(19) United States
(12) Patent Application Publication
(10) Pub. No.: US 2003/0067188 A1
(43) Pub. Date: Apr. 10, 2003

(54) Rescue system for a transport system

(76) Inventor: Giok Djien Go, Idstein (DE)

Correspondence Address: Giok Djien Go, Pfahlgrabenstr. 45, Idstein, 65510, DE

(21) Appl. No.: 09/979,175

(22) Filed: Nov. 20, 2001

Related U.S. Application Data
(63) Continuation-in-part of application No. PCT/DE00/01517, filed on May 13, 2000.

(30) Foreign Application Priority Data
May 19, 1999 (DE) 199 22 985 A1

(51) Int. Cl. B60J 5/00

(52) U.S. Cl. 296/146.11

(57) ABSTRACT

When a transport system whose doors are jammed in a real-world accident, bursts into flame, passengers, trapped therein, can neither detach the doors by themselves nor be rescued by rescue workers arriving too late. To minimize the rescue time and force needed to detach doors the transport system is equipped with a door-detachment device, which is automatically or manually operated, when the transport system comes to a halt, to detach the jammed doors from its body by pulling at least one hinge pin out of the hole of hinge and/or fracturing at least one hinge member. The equations of friction and wire friction are applied to miminize the tensile forces of all wires of the door-detachment device. Thanks to low tensile force badly injured passengers can manually operate it to rescue themselves in a short time before fire engulfs the transport system. In the second feature of the invention, catch bands restrain the detached doors, which, when flying-off, endangers the life of rescue workers and non-participants. In the third feature, a catch pin is exploited to keep the door open in one of the defined positions. In the fourth feature, a visible and audible warning system helps the passengers, usually disoriented due to shock, and/or rescue workers find and operate door-release levers of the door-detachment device as well as the drivers of oncoming vehicles avoid post-accidents.

### CROSS REFERENCE TO RELATED APPLICATIONS

This is a continuation-in-part application of co-pending international application number PCT/DE 00/01517 (WO 00/69702) filed May 13, 2000.

### BACKGROUND OF THE INVENTION

1. Field of the Invention

The present invention relates generally to a rescue system to immediately rescue passengers out of a transport system (train, commuter train, motor vehicle, ship or aeroplane) by means of door detachment, when the transport system comes to a halt and/or catches fire, to guide and ensure the rescue work.

2. Discussion of the Prior Art

In order to formulate in single terminology a generalized definition for the proper term is presented:

| Definition: | Proper Term: |
|---|---|
| “vehicle door” | train- or vehicle door 8, 8S, tailgate door 8T, |
| | revolving door 8V (not drawn), hood 8U, trunk |
| | cover 8Y, double cargo door 8W (not drawn), |
| | sliding door 8X (not drawn) or any vehicular |
| | member (not drawn) which is rotatably and/or |
| | movably connected to the vehicle body 10 by at |
| | least two hinges. |
| “accident” | front-, side-, rear collision, rollover and/or train or |
| | vehicle on fire. |
| “jammed vehicle door” | vehicle door, jammed in the vehicle body 10 in an |
| | accident (FIG. 15), that cannot be opened even by |
| | great force, in contrary to a clamped vehicle door. |
| “vehicle body” | train- or vehicle body comprising a passenger |
| | compartment, vehicle floor, front section- and |
| | rear section of the vehicle body. |
| “rescue workers” | aide personnel such as policemen, doctors, |
| | medical personnel, paramedics, firefighters etc. |
| “tie member” | tie part of hinge such as wire or tie rod |
| “aggressively driven | vehicle is aggressively driven by a road-rage |
| vehicle” | driver into the vehicles, which are in a traffic- |
| | congestion or an accident. Particularly, when it is |
| | dark at night, the life of the rescue workers and |
| | passengers at the accident site is endangered by |
| | vehicles aggressively driven. |
| “pin detachment” | removal of hinge pin from the hole of hinge. |
| “hinge detachment” | detachment of the hinges from the jammed |
| | vehicle door by pin detachment or by fracture |
| | thereof. |
| “expanding piece” | expanding piece by translatory or rotatory |
| | movement of which the hinge is expanded or |
| | broken thus resulting in hinge detachment. |
| “door detachment” | detachment of the jammed vehicle door from the |
| | vehicle body. |
| “externally-operated | door detachment is operated by the rescue |
| door detachment” | workers from outside of the vehicle. |
| “internally-operated | door detachment is operated by the passengers |
| door detachment” | themselves from inside of the vehicle |
| “door detachment | door detachment can only be operated after the |
| occurring after the | accident is over in order to prevent the ejection of |
| accident” | the driver as well as passengers from the vehicle |
| | when it rolls over. |
| “door-release lever” | hand-brake lever, release button of buckle |
| | assembly, press button of buckle assembly, |
| | handle, shown in FIGS. 33 to 37. |
| “supporting arm” | supporting arm of hinge member guides both eyes |
| | of the other hinge member, shown in FIGS. 19 to |
| | 24. |
| “rescue of passengers | salvage and rescue of passengers out of a vehicle |
| out of vehicle involved | or a transport system involved in an accident |
| in an accident” | |

In 1999 a US-Supreme court his imposed a final verdict of $ 1.2 billion compensation damages for the bereaved family on a US car manufacturer due to an explosion of the tank of a 14-year-old car engulfing six family members. It is known in the prior art to provide a door-detachment device to detach the doors, jammed in an accident, from the vehicle body of the transport system. Obviously, there are drawbacks, which deter car-, train- and aeroplane manufacturers to install it in their transport systems:

Exemplified by the related art DE 197 43 965 A1, the door hinge consists of two hinge members, fastened to the vehicle body and vehicle door by rivets having sites of predetermined fracture. In excess of the threshold value the rivets are broken. This feature has the following shortcomings:

In excess of the threshold value in the event of an accident or a crash test the doors are detached while the remaining force deforms passengers or dummies. In the event of a rollover the injured passengers and the items are ejected from the car. Moreover, the free-flying vehicle doors can crush nonparticipants to death.

The vehicle body collapses because the vehicle door is incapable of absorbing and transmitting impact force thereto.

Concerning the door-detachment device ref. to DE 89 14 921 U1 the hinge pin consists of a head, inserted into a hinge member, a piston and a rod, connecting the head to the piston, which is located in the hollow chamber of the lower sleeve of the other hinge member in order to store gas pellets.

When the door is jammed in an accident, later on the gas pellets are detonated. The energy, being set free, destroys the door hinges, the vehicle door and body resulting in fragments of vehicle parts, steel- and glass splinters which endanger life of passengers and nonparticipants.

Regarding the door-detachment device ref. to U.S. Pat. No. 5,011,215 both door hinges of an emergency door of a bus are fastened to an auxiliary bar, which is inserted through an aperture of the vehicle body and the projected part of which has a slot to receive an arm, in connection with a release lever, thus securing the auxiliary bar therein.

When the emergency door is jammed in an accident, the arm should be detached from the slot by moving the release lever activated from outside of the bus. However, the auxiliary bar gets entangled into this aperture of the vehicle body in the state of deformation. The emergency door remains jammed in the vehicle body,

Furthermore, the operation to open the emergency door from outside facilitates thefts to steal items or children to mean mischief.

Additional work to adapt, to seal the assembly auxiliary bar & aperture, to increase the stiffness, lowered by the aperture, and to avoid disturbing noises makes the design of vehicle doors very expensive.

DE 297 13 031 U1 discloses a complicated, bulky door hinge having hinge members, which should be detachable. A hinge member is in plug-in connection with a hinge pin, the conical end portion of which is form-locking connected to the other hinge member and bolted thereto. This method of connection casts doubt about how to cut thread in the end portion and to sustain forces in the operation and great impact forces by means of small bolts. If these small bolts withstand, they are jammed tight in the accident despite using tools (FIG. 15). The door remains jammed. The expensive door hinges cannot be installed in the car because the bulky form needs much space.

The head of a driver was jammed between the upper region of the door frame and the roof (FIG. 15). By means of a hammer two rescue workers drove two wedges into the gap, in which two crowbars were then used, but in vain, the diver-door remained jammed. Taken as given, the total force of two fire-fighters is 5000 N and the effective length of crowbar is 600 mm, “Fₓ” calculated is equal to 6000 N. “Fₓ”>6000 N, undetermined “F_{y}”and “F_{z}”, shown in FIG. 14, are responsible for the state of jamming the door and head.

Only by using a rescue cutter could the driver-door be opened, however the driver, suffering in great pain for over one hour, was already dead! Time is a vital factor for the successful rescue.

A vehicle caught fire when rolling over and coming to rest on its roof, during which the driver, trapped inside, was burnt beyond recognition because he could not open the jammed door.

A heavy rescue apparatus comprises a cutter, hydraulic pump, an engine, a pair of spreading tongs and a 25 metre long, heavy-duty hose. The fire truck incl. the heavy rescue apparatus must be driven to the scene of accident. When the road is blocked, this apparatus must be removed from the truck and carried by four men. The delay of rescue work results in the increase of injury severity.

The maintenance costs for fire trucks and rescue apparatus and the expenditures for firefighters at stand-by are high. The transmission of accident reports and journey to the scene of accident consume time

Injury severity of passengers in the ICE (high-speed) train accident in the German city Eschede was increased due to the time consumed for the rescue, which was hampered due to

cutting off discs, which were suited for steel, but unsuited for aluminium, and

time-consuming operation to (detach the jammed, very stiff aluminium-doors of the carriages.

When crashing into a centre-barrier, a luxury car rolled over on to the opposite highway and lay on its roof. In the darkness this car was rammed by a truck. Both vehicles burst into flames. If the warning device can be switched on automatically in the accident, collision of cars, fire, injuries during forcibly detaching doors, at rescue work and/or during engressing out of vehicles, involved in an accident, can be avoided in a great extent.

### SUMMARY OF THE INVENTION

Accordingly, it is an object of the present invention to provide a rescue system, which is designed to operate easily at low-manufacturing costs and at high reliability,

to immediately rescue passengers out of the transport system by quickly detaching doors when the transport system comes to a halt and/or catches fire, and

to help passengers, despite being severely injured, weak children and/or rescue workers find, particularly when it is dark in the accident site, and operate door-release levers of the door-detachment device and

to warn the drivers of oncoming vehicles in order to avoid post-accidents.

It is a further object of the present invention to exploit a catch pin for a member of doorstop and existing parts of transport systems, which are already put into use in motor vehicles or aeroplanes, for further application in order to avoid recalls, save R&D (Research- and Development) work and manufacturing costs as well as to increase the reliability of the rescue system.

This principle and other objects of the present invention and the aforementioned problem cases as well as requirements therefor are accomplished by the following features (proposals):

A1 Pin Detachment

The hinge of Opel Astra A, provided with three eyes, has a total length of L_{G}=L₁+₂+L₃=50 mm and a deflection of detached pin wₑ =37.5 mm. The hinge of Volvo 850 is provided with two eyes having the length of “L₁” and “L₂”. Accordingly, the total length is shorter.

The deflection of the detached pin for all vehicles and trucks is expressed by the following equation

wₑ=20 to 60 mm.

Upon the use of a deflecting pulley 30 to 44 with diameter e.g. of 100 mm or 200 mm, shown in FIGS. 1, 21, 36

the rotating angle “oe” is calculated between 23° to 68.8° or between 11.5° to 34.4° .

The conventional cable, wire or rope pulley for crane and winch can serve as deflecting pulley. The space-saving deflecting pulleys are suitable for all vehicle doors 8, 8S to 8Y, the vehicle body 10 and vehicle floor 13. The calculated force “Fₓ” of 6000 N, the undetermined forces “F_{z}” and “F_{y}” are distributed at the circumference of the driver-door jammed in the passenger compartment. Nowadays, the hinge is provided with grease lubrication to lower friction, so the friction coefficient “μ” may be equal to 0 1. Let the pair of hinges 5, 5₁, 5₂ and the door lock 14, shown in FIGS. 1, 15, be uniformly loaded by “Fₓ”, “F_{y}” and “F_{z}”, the tensile force of each hinge is obtained from

Eq. (1): Z₁ᵤ=Z₂ᵤ=Z₃=(0.1 F_{y}+F_{z})/3+F_{zE}+200 N

Z₁ᵤ=Z₂ᵤ =0 1 F_{1y}+f_{zE}+200N

Because the mating hinge members 5.1, 5.2 support each other in z-direction, the force “F_{1z}” has no influence on the magnitude of “Z₁ᵤ” and “Z₂ᵤ” when the pin is detached. When being assembled the hinge pin is compressed into the holes of both hinge members. Accordingly, a tensile force “F_{zE}” must be applied for the detachment thereof. The addition of both tensile forces yields the tensile force “Z.” of the door-detachment device 15 to detach the vehicle door 8j

Eq. (2): Z_{z}=Z₁ᵤ+Z₂ᵤ=0.2 F_{1y}+2 F_{zE}+400N.

This total force “Z_{z}” is lower than “f”, shown in FIG. 14,

A2 Decrease of Tensile Forces

The wires 2, 2S, 2U, 2Y of the jammed vehicle doors are provided with sites of predetermined fracture, so the fracture occurs upon the increase of the tensile force. This feature enables an injured passenger to rescue himself by detaching the series-connected, less deformed vehicle doors 8, 8S of co-driver side and the other 8U, 8Y, shown in FIG. 36, even though a gear to lower the tensile force is not implemented. Evidently, the medical care as well as the salvage can be performed far more easily, when all the vehicle doors 8, 8S are detached, through which the rescue workers have free access to the passengers.

A gear consisting of gear wheels is too expensive for a single rescue operation. Far cheaper is the use of a gear G1 having deflecting pulleys characterized by the parameters such as friction coefficient “μ”, number of turns “i” and/or reduction-ratio “r₂/r₁” (FIG. 12). The tensile force is governed by the equation of wire friction:

Eq. (3): Zₙ=Zₜ/e^{μoe}=Zᵢ/e^{2pμi}, where p=3.141 is.

Let be μ=0.15 for steel, i=3 and Zₜ=1000 N+Z_{G} for the jammed driver-door 8, deformed tailgate door 8, deformed hood 8U and the other noon-deformed doors and be set in Eq. (3), which is rewritten into

Eq. (4): Zₙ=59.2 N+0.059 Z_{G}.

Exemplified by a belt would about a cast iron, the friction coefficient “V” is increased up to 0.4 to 0.5 when the wire 2n, 2n of gear G1 is surrounded by hose 9.8. For μ=0.3, Eq. (4) changes into

Zₙ=3.5 N+0.0035 Z_{G}.

Thanks to the reduction-ratio “r₂/r₁” of another gear G2, shown in FIG. 13, the decrease of tensile force is governed by the following equation

Eq. (5): Zₙ=(r₁ Zₜ)/(r₂ e^{2pμ (t}₁⁺¹₂⁾).

For r₂/r₁=2.1,i₁=2 and i₂=3 the force “Zₙ” is calculated:

4.3 N+0.0043 Z_{G} for μ=0.15,

0.89 N+0.00089 Z_{G} for μ=0.2 and

0.038 N+0.00004 Z_{G} for μ=0.3.

Is “Z_{G}” as big as “Zₜ”, the tensile force is extremely low, hence, an injured passenger still has the strength to exert force in order to rescue himself and the other injured passengers out of the vehicle despite the four heavy vehicle doors.

When the series-connected vehicle doors 8, 8S of driver side are jammed, “F_{y}” is large, hence, an injured passenger must apply larger tensile force.

A3 Tensile Forces in Opposite Direction The upper and lower pin of the hinge 5i of vehicle door 8;, shown in FIG. 21, can be detached by the tensile force “Z₁ᵤ” and “Z₁ₒ”, so the tensile force “Z_{z}” of door-detachment device 15i to detach door is governed by the equation of wire friction

$$\begin{matrix}Eq . ( 6 ) : {Z}_{z} = {Z}_{z} / {e}_{c}^{2 p μ i} \\ = ( {Z}_{1 u} + {Z}_{1 o} ) / {e}_{ a c}^{2 p μ ( i + i )} .\end{matrix}$$

The force “Z_{z}” is substantially lower than “Z_{z}”according to Eq. (2), where “iₐ”, “i_{b}” and “i_{c}” are the number of turns of deflecting pulley 32a, 32b and 33 and “iₐ” is “i_{b}”. The number of turns is arbitrary. The twin-deflecting pulley 32 comprises two deflecting pulleys 32a and 32b which rotate in opposite direction “a” and “b”.

The tensile force “Z_{z}” is further reduced by the increase of the friction coefficient when the wire is surrounded with the hose 9.8.

A4 Decrease of Deflection by Detachment of Two Hinge-pin Members

Two hinge-pin members 6go, 6gu of hinge 5g are force-locking connected by two coupling members 6.1o, 6.1u to a pair of guide tubes 6.5o, 6.5u, movable into each other, shown in FIGS. 17, 18. Both these hinge-pin members have the function of the hinge pin 6g to form-locking connect the body-hinge member 5.1g, fastened to the vehicle body 10, with the door-hinge member 5.2g, fastened to the door 8. When pulling the tie rod 2g a pair of upper swinging arms 6.2o compresses the coupling member 6.1o upward and a pair of lower swinging arms 6.2u the coupling member 6.1u downward, thereby resulting in the detachment of the door-hinge member 5.2g from both hinge-pin members. However, the form-locking connection of both guide tubes remains intact.

This feature has the advantages that

the deflection of two hinge-pin members is shorter about “L₁” or “L₂”;

the tensile forces “Zⱼᵤ” and “Zⱼₒ”, exerted in the opposite direction, are neutralized;

the disengagement of two hinge-pin members from the hinge member 5.2g can be determined either with or without time delay. If the upper pails 6.1o, 6go, 6.5o and the lower parts 6.1u, 6gu, 6.5u are identical, the disengagement occurs without time delay;

the guide tubes, movable into each other, perform the function of guidance during the detachment of the pin and

the chance for a successful rescue increases thanks to the decrease of time associated with the decreased deflection “wₑ”of pin detachment from Lₑ=37.5 mm to L₃=25 mm, about 33.3% for Opel Astra.

A5 Decrease of Deflection by Guidance of Eyes of Hinge Members

During the detachment of the pin the eyes of hinge member 5.2h to 5.2j, shown in FIGS. 19 to 24, are guided by a pair of supporting arms 5.4h of the other hinge member 5.1h or by supporting arm 5.4i, 5.4j of the other hinge member 5.1i, 5.1j. Concerning the hinge detachment the time and tensile force are decreased because

the supporting length “L₂” is smaller;

during the detachment of the pin the force “F_{1xy}” is sustained by the pair of supporting arms or by the supporting arm; and

the sliding supporting arm 5.4i, 5.4j or the slide retainer 5.3h is pulled by a low tensile force of “μF_{1y}”, after the hinge pin has been detached. Under load of force “F_{1xy}” the hinge members 5.2h to 5.2j of the vehicle door move thus resulting in a door detachment, shown in FIG. 20.

A6 Decrease of Time and Force by Hinge Detachment

Forces “F₁ₓ” and “F_{1y}” are imposed not on the expanding piece 3a to 3f (FIGS. 2 to 11), but on the surface of the inner cylinder of hinge member 5.1c (FIG. 5). For the purpose of hinge detachment the hinge member 5.1a to 5.1f must be expanded, hence, its stiffness is significant for the magnitude of the tensile force “Z₁”, “Z₂₀”, “Z₁ᵤ”, “Z₁ₒ” of the wire thereof. Evidently, the tensile force is independent of the forces “F₁ₓ”, “F_{1y}” and “F_{1z}”, shown in FIG. 1, hence, the expansion of both hinge legs 5.11a to 5.11f; 5.12a to 5.12f or the fracture of hinge member 5.1a to 5.1f is achieved by a very low tensile force upon

translatory movement of expanding pin 3a to 3c, the end portion 3.2a to 3.2c of which, shown in FIGS. 2 to 5, has a conical shape;

rotatory movement of expanding wheel 3d to 3e, the rim of which, shown in FIGS. 6 to 10, has an increasing thickness “t₁”; or

rotatory movement of expanding wheel 3f, having a side with slope angle “oeₒ”, showning in FIG. 11. To save costs the hinge member 5.1a to 5.1f can be made of a component by extrusion, depth extrusion or casting.

After the expanding pin 3a his been moved by the tensile force “Z₂₀” of wire 20a until its stop ring 3.3a with the largest diameter “d₃” (FIG. 2) takes effect the wire 2a must be pulled to detach the pin. The pulling operation of two wires in succession raises the problem of synchronization, which can be resolved by

wire 2b, consisting of two wire portions having a clearance to permit the expansion or fracture of the hinge member where, at first, the expanding pin 3b is moved by pulling the second wire portion. In case of expansion of the hinge member the wire 2b of hinge pin 6b is further pulled to detach the pin;

wire 20c, by the tensile force “Z₂₀” of which the expanding pin 3c (FIG. 4) is moved to fracture the hinge member;

rotatable, expanding wheel 3d to 3f to expand and/or to fracture the hinge member. The angle “oe₁ is arbitrary, but chosen about 270° (FIG. 8). The tensile force of Eq. (3) is substantially decreased in conjunction with larger angle; or

a pair of sites of predetermined fracture, arranged to the upper and lower surface of hinge member 5.1c to 5.1f, facing each other, in the region “s” to “sₛ”, shown in FIGS. 4, 7 to 11. The stiffness of the hinge member, weakened by the sites of predetermined fracture “sₛ”, is increased by enlarging the outer diameter “D” of the hinge (FIG. 5).

A7 Flying-off Vehicle Doors

Due to the sudden detachment of door great energy is released. The vehicle doors, loaded thereby, flies off, thus endangering the life of the rescue workers. Hence, a catch band 1, 1S to 1U (FIGS. 1, 3, 14) or catch pin 1d (FIGS. 6 to 8) is invented to prevent the vehicle door from flying off. To disassemble the vehicle door, after the operation of door detachment has been performed,

the catch band 1 is cut or

the tension spring 1.3d is pressed in to release the catch pin 1d from a doorstop retainer 1.2d. The catch pin 1d further serves as a member of a doorstop which keeps the opened door in position “O₁”, “O₂” or “O₃”.

A8 Activate a Freewheeling Device to Detach Door

To save costs the sensors 84A to 84C, 84F, 84G of front and side airbags 85A to 85C, belt pretensionier 91.9, 91.9S and clamping device of a belt retractor 92 can further be used. However, these sensors are incapable of measuring the acceleration in the event of rear collision of rollover. MB convertible of the upper class is provided with a rollover bar ref. to U.S. Pat No. 5,284,360 (DE 4130470 C1). To protect passenger in the event of rollover the rollover bar 93 (not drawn) is activated by sensor 84H (not drawn).

In order to more accurately sense the acceleration in x-, y- and z-direction the new 3-D sensor, reported by the Fraunhofer Magazine 4/1997, is recommended for use.

Because trains travel only in one direction, one sensor 84D is sufficient to sense the acceleration in front or rear collision.

A temperature sensor 84D is provided for sensing the fire 66 in the engine compartment 65 due to the fissure of gasoline line, in the motor vehicle due to the explosion of the tank or in the train A freewheeling device 50, 50a of door-detachment device, shown in FIGS. 30, 36, can be activated only in an accident in order to prevent theft in the vehicle. When an accident does not occur and the door-release levers 86, 88A to 88D, 91.1, 91.1S, 91.2S are operated, the wires 2n1 to 2nn move, but the wire 2n, shown in FIGS. 26 to 29, 31, 32, does not. The freewheeling device is in the state of non-lock and the function of the doors remains unaffected.

Contrarily, in an accident the sensor activates a motor 51.5 (not drawn) to rotate a coupling casing 51, 51a, having control edges 51.2x, 51.2y, 51.2z, about the z₁-axis in rotating direction “D₁”, shown in FIGS. 27 to 29. When rotating about angle “β₁”, shown in FIG. 30, the control edges 51.2z are in contact with both spacers 50.14, whose shaft 50.5 is biased by springs 50.11. Both end portions of shaft 50.7 snap into the oblong holes 50.2v of both leaf springs 50.2 and engage thereto. The freewheeling device is in the state of lock. Hence, the wire 2n is loosely connected to the wires 2n1 to 2nn. After the round retaining segments 51.2u have been rotated about angle “βB₁” or further, the operation of pulling one of the latter triggers the movement of the shafts 50.7, 50.5, 50.3 along the oblong holes 50.13 and the detachment of doors.

If for safety reasons the power supply of a car battery 89, shown in FIGS. 33, 36, must be cut off in an accident, the power supply can be ensured, for example, by rechargeable batteries 89a (not drawn), connected to the current circuit.

Additional switches and levers serving as door-release levers would confuse the passengers, usually disoriented due to shock in an accident, the present vehicle parts, already installed, such as switches, swinging arms and levers lend themselves for further use in association with spoken instructions. Upon the evaluation of the vehicles in the accidents, the deformation of the steering wheel and the space for the feet as well as the intrusion of pedals have been observed. For this reason the further use of the Mercedes Benz-foot brake lever (not), brake pedal 82, clutch pedal 81, steering wheel 80 and switches (not drawn) on the dash board (instrument panel), shown in FIG. 36, is ruled out.

In order to maintain manufacturing costs as low as possible and the custom ways such as a passenger steps out of the vehicle, the following vehicle parts, the respective functions of which remain unaffected, are adapted to the operation of door detachment:

hand-brake lever 86, accessible for all passengers. Due to the connection of the hand-brake lever 86 with the brake wire 86.3 and auxiliary wire 86.2, a gear G3 foor dual operation “hand braking and door detachment” must be provided with an adjusting mechanism. With regard to the reduction-ratio “c₂/(c₁+c₂)” the distances of both wire rings 86.6, 86.7 to the z₂-axis are adjusted by moving along their respective members 73.2, 73.4. Later on, both wire rings are secured on the swinging arm 73 by tightening two pairs of nuts 73.3, 73.5. Only when the freewheeling device is actuated in an accident does the rotation of the hand-brake lever about the x₂-axis result in the dual operation of

a hand-brake lever about the rotating angle “β” and

a door detachment about a rotating angle up to “β”;

press button 91.2, 91.2S of buckle assembly 91, 91S, when depressed, the release wire 91.3 is pulled to switch on a motor 91.7, supplied with current by the sensor 84A to 84H in an accident;

release button 91.1, 91.1S of buckle assembly 91, 91S, when depressed, the seat belt 90, 90S is disengaged from the buckle assembly and the release wire 91.3 is pulled to switch on a motor 91.7, supplied with current by the sensor 84A to 84H in an accident; and/or

door-release levers 88A to 88D.

A vehicle, travelling along a mountain, is laterally rammed by a truck, where both vehicles become entangled. To proceed with the rescue work the rescue workers must find an entry to the deformed car, thus, wasting precious time and deteriorating the chance to survive. For this reason, at least one entry to the door-release lever must always be accessible, shown in FIG. 36:

door-release levers 88A, 88B Right-hand drive vehicle is constructed with a tank-space 77R for a tank filling tube 87.1 incl a tank cap 87.2 or left-hand drive vehicle with a tank-space 77L. Preferably, both tank-spaces 77R, 77L are exploited to house both door-release levers.

One of which is always accessible in a side collision, for example, into a bridge column;

door-release lever 88C, arranged to the vehicle floor, which is always accessible when the vehicle lies on its roof on a road; and

door-release lever 88D to open the trunk cover 8Y. To realize two functions of this handle, a reduction-ratio by means of a swinging arm 73, similar to the swinging arms 74, is needed

A9 Independent Door-detachment Devices

For ships and aeroplanes both centralised embodiments are too intricate and expensive due to long distance between the door-release levers and the doors as well as emergency doors and due to many door-release levers of the seals, for example 600 seats of Airbus A380. In order to resolve this problem the doors, being far from each other, are equipped with independent door-detachment devices (FIG. 37).

A10 Visible and Audible Warning System

Despite the label, showing that the vehicle, involved in an accident, is equipped with a door-detachment device, rescue workers encounter the problem, when it is dark, to find the vehicle and its door-release levers as well as to operate them. Is the warning device not switched on, aggressively driven vehicles pose a threat to the rescued passengers and/or the rescue workers. When the vehicle bursts into flames due to crack of gasoline supply and/or explosion of gasoline tank there is a danger of panic among the passengers who no longer have the full power of perception to find and operate the door-release levers, thus being in despair and making an attempt to open the doors in common way. Due to great consumption of oxygen by fire there is not much time left for the rescue operation by the passengers themselves or by the rescue workers. The door-detachment device remains unused. Consequently, there is a need for a visible and audible warning system 70, 70a to 70c, shown in FIGS. 33 to 37, to give the passengers and/or rescue workers

information about the location of the door-release levers by warning lights 4a to 4n and the location of the vehicle, involved in an accident, by warning lights 4a to 4d and

instruction of how to operate the door-release levers by loudspeakers 7a to 7n and/or loudspeakers of cellular phone, cell phone or phone. The flashing of the warning lights 4a to 4d draws the attention of the drivers of oncoming vehicles. The car-, train- and aeroplane manufacturer can make its own decision for switching on the warning device during the accident, at the start thereof or when the event thereof is over. Advantageously, the warning device is switched on at the start of the accident because the passengers have the full power of perception or orientation and more time is available for the drivers of oncoming vehicles.

Cell phone, radio and/or navigator, serving as reliable audible warning system, is automatically switched on by

current, supplied in the current circuit in the accident, or

activating the switch, connected to a main current circuit, in the accident.

### BRIEF DESCRIPTION OF THE DRAWINGS

A number of embodiments, other advantages and features of the present invention will be described in the accompanying drawing with reference to the xyz global coordinate system:

FIG. 1 is a perspective view of the 1st embodiment of a hinge 5, under load of “F₁”, a hinge member 5.1 of which is fastened to the vehicle body 10 and the other hinge member 5.2 to the vehicle door 8, where both hinge members are loosely connected by catch band 1 and a hinge pin 6 or 6ₒis provided with a wire 2 or 2ₒ.

FIG. 2 is a perspective view of the 2nd embodiment of a hinge member 5.1a, subdivided into two hinge legs 5.11a, 5.12a, between which a longitudinally movable, expanding piece 3a with a stop ring 3.3a is located.

FIG. 3 is a perspective view of the 3rd embodiment of a hinge member 5.1b, subdivided into two hinge legs 5.11b, 5.12b, which are loosely connected by catch band 1 and between which a longitudinally movable, expanding piece 3b is arranged.

FIG. 4 is a perspective view of the 4th embodiment of a hinge member 5.1c, subdivided into two hinge legs 5.11c, 5.12c, between which a longitudinally movable, expanding piece 3c is arranged and sites of predetermined fracture are arranged to upper and lower surface of which in the region from “s” to “sₛ”.

FIG. 5 is a cross-sectional view of the hinge member 5.1c, loaded by “F₁ₓ” and “F_{1y}”, along the line A-A of FIG. 4

FIG. 6 is a perspective view of the 5th embodiment of a hinge 5d, two hinge members 5.1d, 5.2d of which are loosely connected by catch band 1d and a rotatable, expanding piece 3d of which is inserted between two hinge legs 5.11d, 5.12d.

FIG. 7 is a top view of a doorstop with the hinge 5d, when the door is kept open in position “O₁”, “O₂” or “O₃”, according to the arrow C of FIG. 6.

FIG. 8 is a side view of the doorstop, when the door is opened in position “O₃”, according to the arrow D of FIG. 7.

FIG. 9 is a schematic, perspective view of the 6th embodiment of a hinge member 5.1e having a retaining pin 3.1e and rotatable, expanding piece 3e.

FIG. 10 is a cross-sectional view of the hinge member 5.1e along the line B-B of FIG. 9.

FIG. 11 is a cross-sectional view of the 7th embodiment of a hinge member 5.1f having a hinge leg 5.11f inclined about “oeₒ”.

FIG. 12 is a perspective view of the 1st embodiment of a gear G1 to lower the tensile force “Zₜ” and of the embodiment of a latch device equipped with a blocking shaft 11.

FIG. 13 is a perspective view of the 2nd embodiment of a gear G2 to lower the tensile force

FIG. 14 is a perspective view of a vehicle equipped with the hinges 5, 5S, 5T, 5U, catch bands 1, 1S, 1T, 1U and swinging flap 87A, where the vehicle doors 8, 8S, tailgate door 8T and hood 8U are loaded by “F”, “Fₛ”, “F_{T}” and “F_{U}”.

FIG. 15 is a side view of a vehicle, where the head 60.1 of the driver is jammed between the door 8ⱼ and roof 10.1.

FIG. 16 is a side view of a vehicle on fire.

FIG. 17 and 18 are schematic, perspective views of the 8th embodiment of a hinge 5g, the coupling members 6.1ₒ, 6.1u of which force-locking connect two hinge-pin members 6go, 6gu to a pair of guide tubes 6.5o, 6.5u, one of which telescopes into the other.

FIG. 19 is a perspective view of the 9th embodiment of a hinge 5h, the supporting arms 5.4h of which are sustained by slide retainer 5.3h and form-locking connected to the eyes of a hinge member 5.2h.

FIG. 20 is a top view of the hinge 5h, the hinge member 5.2h of which is loaded by “F_{1xy}”, according to the arrow H of FIG. 19.

FIG. 21 is a perspective view of the 10th embodiment of a hinge 5i, a supporting arm 5.4i of which, longitudinally movable in the hinge member 5.1i, sustains the eyes of a hinge member 5.2i, and the embodiment of the deflecting pulleys 30, 32, 33, wires 2, 2iu, 20i, 21i, a wire 2io of the lower hinge 5io of the vehicle door 8; and the common wire 2 of a door-detachment device 15i.

FIG. 22 is a top view of the hinge 5i, the hinge member 5.2i of which is loaded by “F_{1xy}”, according to the arrow I of FIG. 21.

FIG. 23 is a cross-sectional view of the hinge member 5.1i, in which the supporting arm 5.4i is secured by retaining pin 25i, a long the line J-J of FIG. 21.

FIG. 24 is a perspective view of the 11th embodiment of a hinge 5j, a supporting arm 5.4j of which, longitudinally movable along a hinge member 5.1j, sustains the eyes of a hinge member 5.2j.

FIG. 25 is a perspective view of the 1st embodiment of a door-release lever 86 and the 3rd embodiment of a gear G3 for the dual operation “hand braking and door detactment”.

FIG. 26 is a perspective view of the gear G1 having an entrance wire 2n, exit wire 2n and of a freewheeling device 50 with exit wires 2n1 to 2nn.

FIGS. 27 and 28 are perspective views of the 1st and 2nd embodiment of the freewheeling device 50, having a U-shaped coupling casing 51 and of the freewheeling device 50a, having a U-shaped coupling casing 51a in the state of non-lock (freewheeling).

FIGS. 29 and 30 are top views of the freewheeling device 50, having a U-shaped coupling casing 51 in the state of non-lock and lock, according to the arrow E of FIG. 27.

FIG. 31 is a cross-sectional view of the freewheeling device 50, having the U-shaped coupling casing 51 in the state of on-lock along the line F-F of FIG. 29.

FIG. 32 is a cross-sectional view of the 3rd embodiment of a freewheeling device 50b, having a U-shaped coupling casing 51b in the state of non-lock along the line F-F of FIG. 29.

FIG. 33 is a perspective view of the 2nd and 3rd embodiment of a door-release lever 91.1 and 91.1S as well as the 1st embodiment of a warning system 70.

FIG. 34 is a perspective view of the 2nd embodiment of the members 71a, 72a of a warning system 70a.

FIG. 35 is a perspective view of the 3rd embodiment of the members 71b, 72b of a warning system 70b.

FIG. 36 is a perspective view of the 1st to 7th embodiments of a door-release lever 86, 91.1, 91.2S, 88A to 88D, the 1st embodiment of a rescue system 55, equipped with sensors 84A to 84G, the gear G1, the freewheeling device 50, the door-detachment device 15, 15a to 15j and the warning system 70 and of a vehicle whose contour is defined by the doors 8, 8S, 8U, 8Y, a front bumper 12V and rear bumper 12H.

FIG. 37 is a view of the 3rd embodiment of a rescue system 55c of a transport system.

### DESCRIPTION OF THE PREFERRED EMBODIMENTS

Beyond doubt, the function of the door-detachment device is well described in the preferred embodiments of the prior art. However, in the scope explanation of how to manufacture and assemble the parts thereof in the motor vehicle is omitted, hence, the aforementioned problems related thereto remain undetected. One of the objects of the present invention, aforementioned, is to use the existing parts of transport systems. Hence, all subjects regarding assembling, manufacturing and using parts thereof must be taken into account when the function of the rescue systems and process to assemble them are described in order to give readers a better understanding thereabout and avoid failure in assembling, manufacturing and real-world accidents.

The features are applicable for trains, commuter trains, ships, boots, aeroplanes and motor-vehicles (car equipped with all arbitrary number of vehicle doors, truck, bus, van etc.). The advantage of the force-locking connection of the hinge member 5.1, 5.1a to 5.1j with the vehicle body 10 and of the other hinge member 5.2, 5.2a to 5.2j to the vehicle door 8, 8S to 8Y is attributed to the stiffness of vehicle body, which is far larger than that of the vehicle door, thus more suitable for the accommodation of the door-detachment device, which is better protected against the deformation. The arrangement of both hinge members can be exchanged to the respective vehicle members, however, this has the following disadvantages:

The door-detachment device, installed in the vehicle door, fails when being totally deformed by great impact energy. Moreover, no space is left to house the door-detachment device, because the cavity of the vehicle door must accommodate a side airbag, an electrical window-pane regulator, loudspeakers 7e, a door lock with anti-theft device and reinforcing elements 8.1.

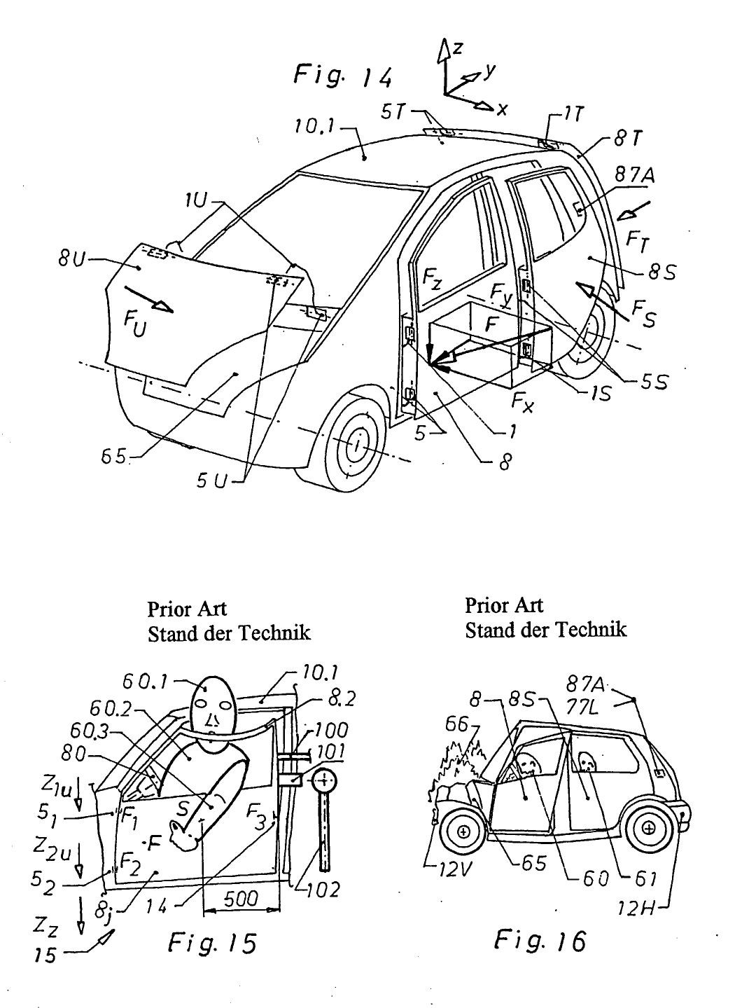

In the 1st embodiment of a hinge, shown in FIGS. 1, 14 to 16, 36, the vehicle door 8, 8S, reinforced by reinforcing elements 8.1, is rotatably attached to the A- or B-post section of the vehicle body 10 via at least two conventional hinges 5, 5S. For the purpose of receiving wires 2, 2ₒ the hinge pins 6, 6ₒ must be prolonged (FIGS. 1 and 15). The wire 2ₒ connects both hinge pins 6, 6ₒ, where the wire 2 for the door detachment is fastened to a 2nd bore of the hinge pin 6 of lower hinge 5_{2.} This cost-effective, simple feature of the door-detachment device 15, 15a to 15j of the vehicle door 8, 8S to 8Y, resolving the aforementioned drawbacks of DE 197 43 965 A1, DE 89 14 921 U1 and U.S. Pat. No. 5,011,215, ensures two principle functions of the doors to protect passengers in an accident and items, stored inside thereof, when the doors are closed and to transmit impact energy to members of vehicle body, exemplified by EP 0869878 B1.

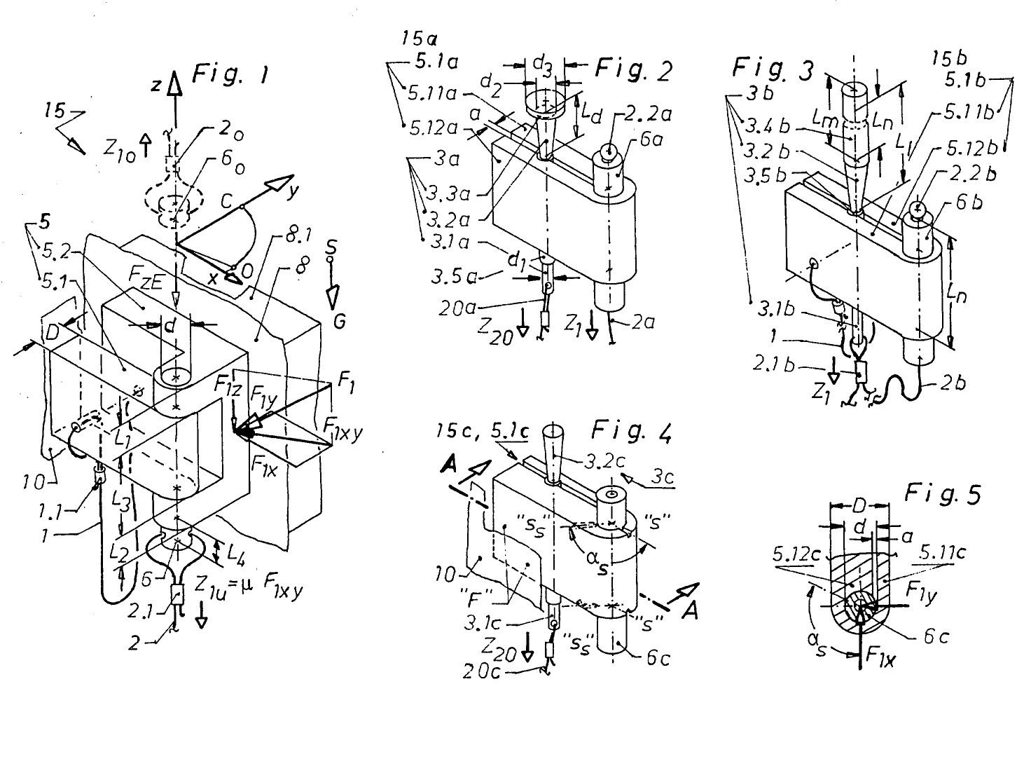

In the 2nd to 4th embodiments of the hinge, shown in FIGS. 2 to 5, the wire 2a to 2c with ball 2.2a to 2.2c is projected through the hole of hinge pin 6a to 6c for the purpose of pin detachment and/or fracture of the hinge. To dampen noise a soundproofing material 3.5a to 3.5c is recommended for use on the cylindrical member 3.1a to 3.1c of longitudinally movable, expanding element 3a to 3c, which is located on two cylindrical surfaces of the both hinge legs 5.11a to 5.11c and 5.12a to 5.12c and biased thereby.

The conical member 3.2a to 3.2c, determined by “d₁”, “d₂” and “L_{d}”, is of significance for the expansion of both hinge legs. The hinge pin, when detached, deflects in a length of “Lₙ”, hence, the cylindrical member 3.4b must be designed with a length of Lₘ>Lₙ. Alternately, the expansion of both hinge legs in response to the movement of conical member can be designed to fracture the hinge member 5.1a to 5.1c, provided with sites of predetermined fracture “s”, shown in FIG. 4.

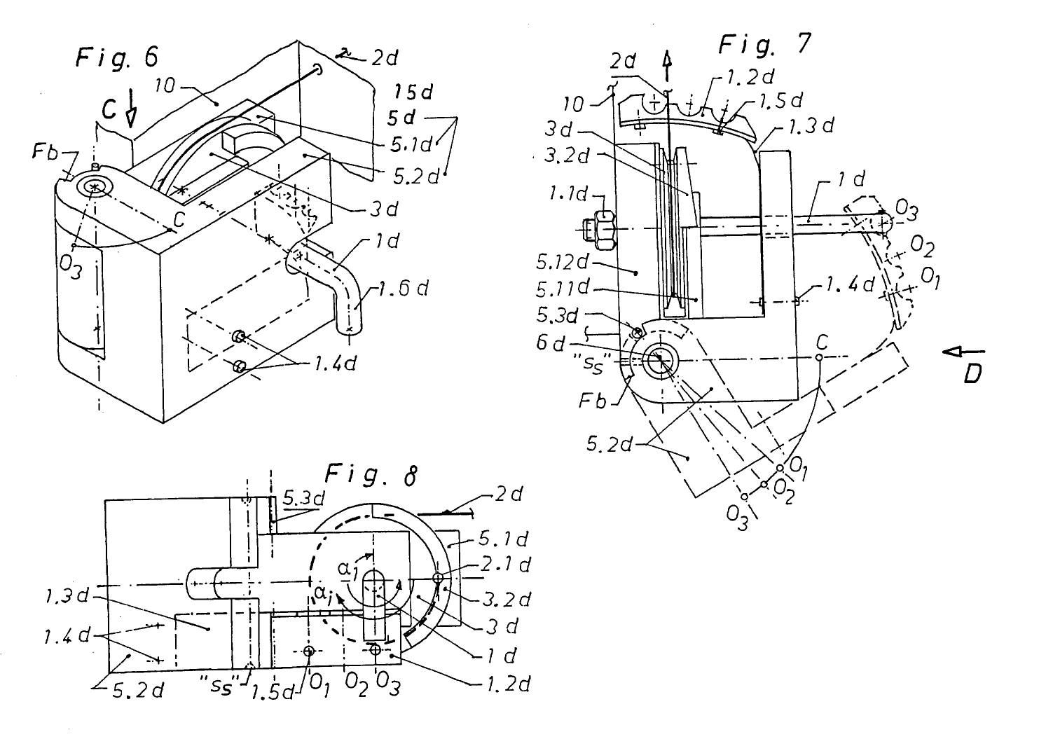

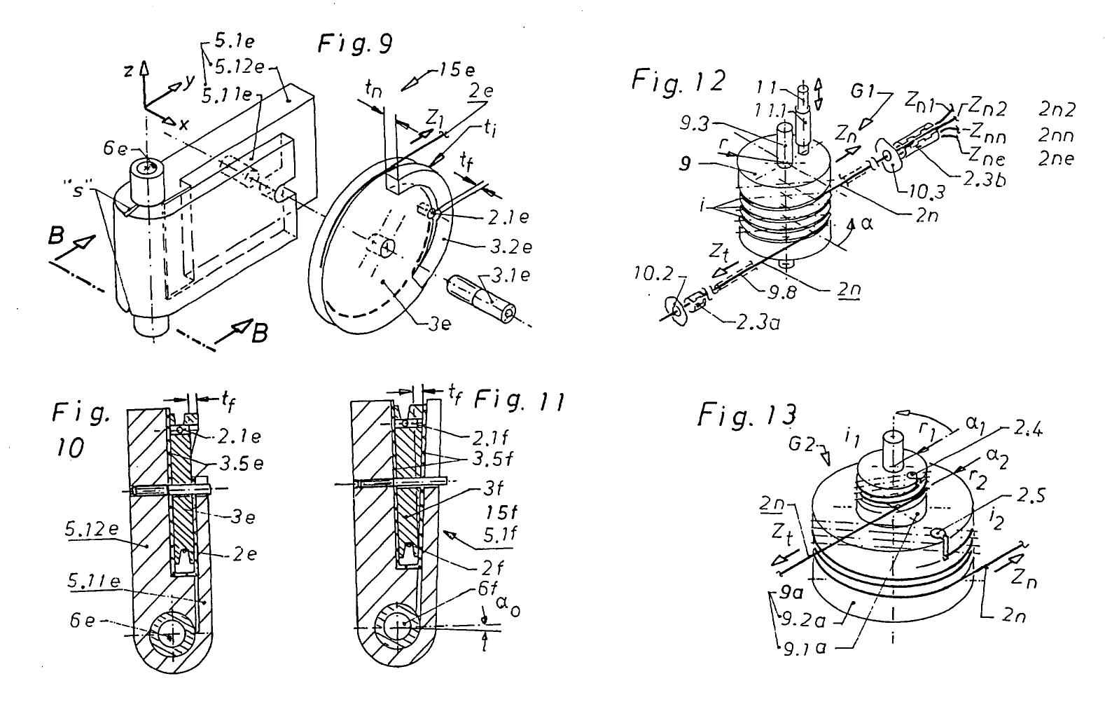

In the 5th to 7th embodiments of a hinge, shown in FIGS. 6 to 11, the retaining pin 2.1d to 2.1f of wire 2d to 2f is projected into the retaining hole of rotatable, expanding wheel 3d to 3f. This expanding wheel with soundproofing proofing material 3.5d to 3.5f is inserted between both hinge legs 5.11d to 5.11f and 5.12d to 5.12f, biased thereby and rotatably attached by bolting a retaining pin 3.1e, 3.2f to the hinge leg 5.12e, 5.12f or a catch pin 1d to the hinge leg 5.12d and nut 1.1d. The expansion of both hinge legs resulting in a pin detachment and/or fracture of hinge member 5.1d to 5.1f, provided with sites of predetermined fracture “s”, is determined by the thickness “t₁”of the rim of expanding segment 3.2d, 3.2e in dependence on the rotating angle “oe₁”, shown in FIGS. 8 and 9, or the slope angle “oeₒ” of expanding wheel 3f and of hinge leg 5.11f, shown in FIG. 11.

In order to save costs, parts and space the door detachment device serves as a doorstop with dual function, catching the flying-off vehicle door and keeping door open, which comprises a doorstop retainer 1.2d, a tension spring 1.3d. fastened to the hinge member 5.2d by two pins 1.4d, and a catch pin 1d. A downward-directed portion 1.6d of catch pin 1d, biased by tension spring 1.3d, engages in one of the cut-outs of the doorstop retainer 1.2d in position of “O₁”, “O₂” or “O₃” to keep the vehicle door open. The range of door-opening is limited by the contact of both surfaces Fb with the stop pills 5.3d in the position “O₃”. When closing the door to the position “C”, the hinge member 5.2d, having an aperture, into which the catch pin 1d moves, is rotated.

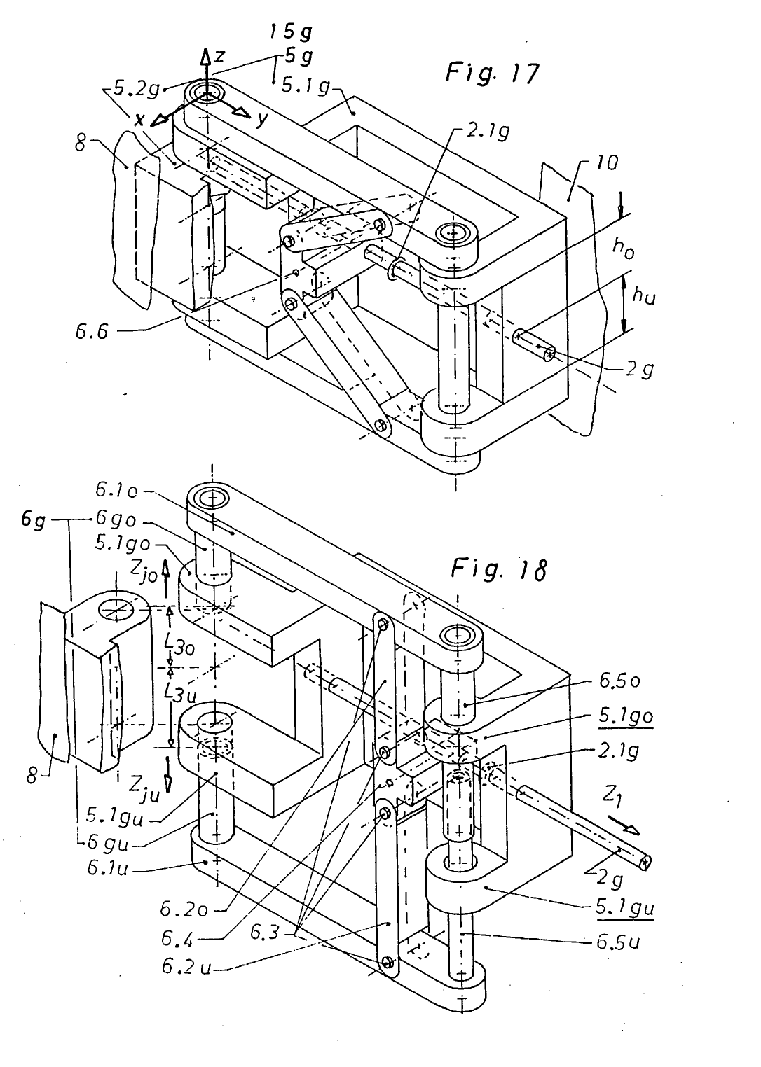

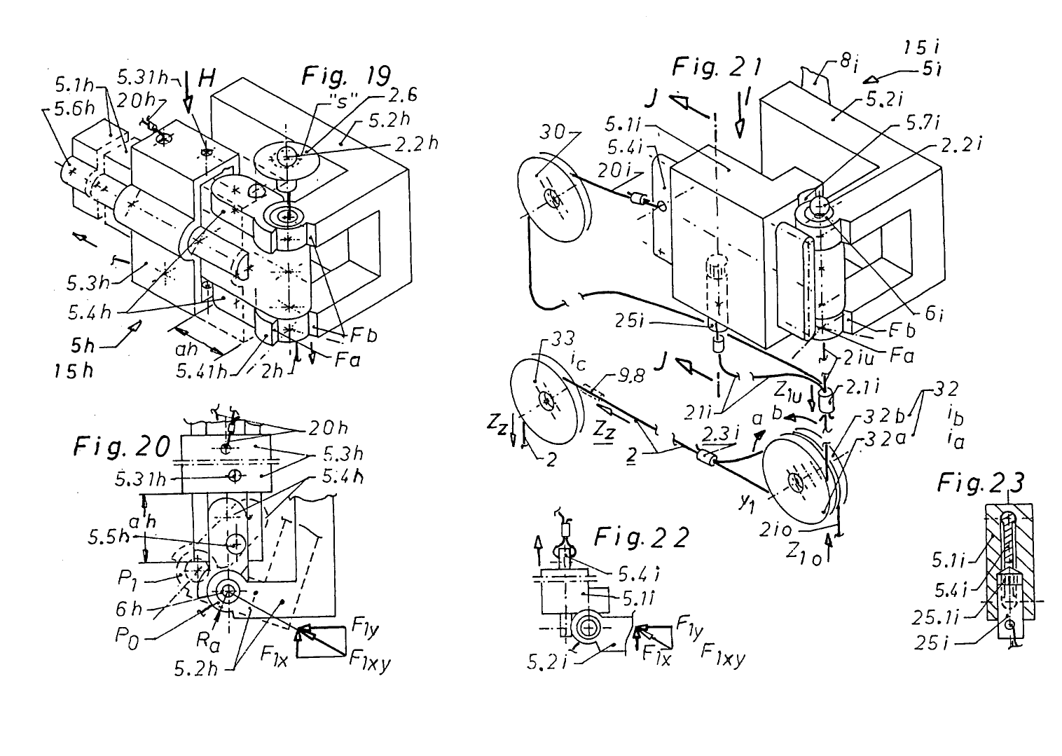

In the 8th embodiment of a hinge, shown in FIGS. 17 to 18, two pin-members 6go, 6gu of hinge pin 6g and a pair of guide tubes 6.5o, 6.5u, one of which telescopes into the other, are fastened to the respective coupling members 6.1o, 6.1u, that are connected to each other by slide shoe 6.4, a pair of upper swinging arms 6.2o a pair of lower swinging arms 6.2u and four pins 6.3. After having projected through the slide shoe 6.4 and hinge member 5.1g the tie rod 2g is secured by retaining ring 2.1g, also, acting as a stop ring, and the slide shoe 6.4 is secured by pin 6.6. Owing to a form-locking connection of the hinge-pin members (6go, 6gu) with a hole of the upper and lower hinge-pin flange (5.1go), 5.1gu) and of the upper guide tubes (6.5o) with a hole of the upper and lower guide-tube flange (5.1go, 5.1gu) the pulling of tie rod 2g up to the stop ring 2.1g gives effect to a movement of the coupling members 6.1o, 6.1u, whereby the hinge member 5.2g is detached from both pin-members

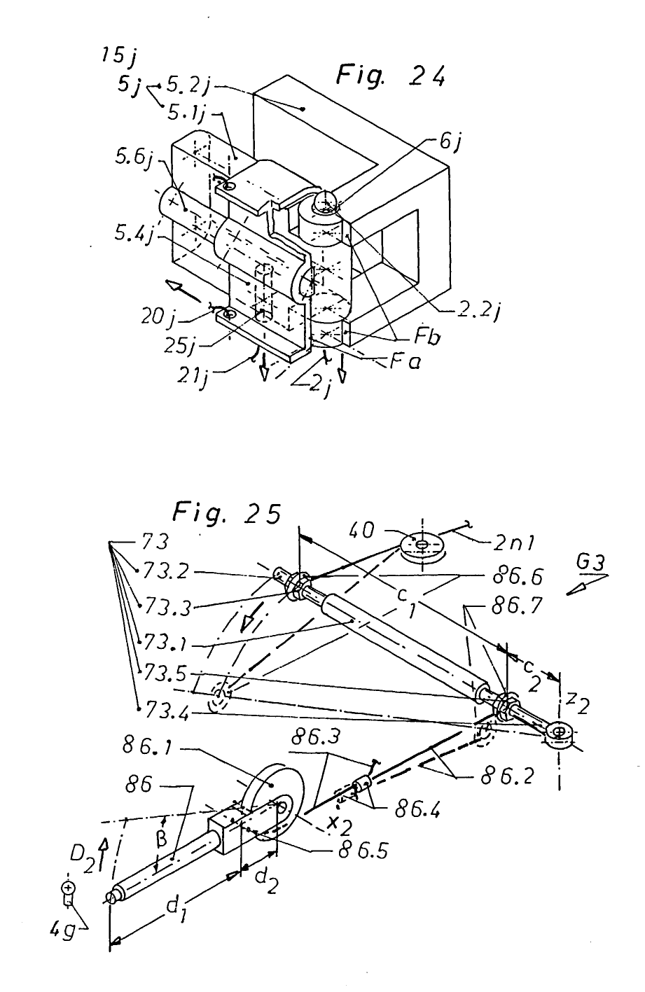

In the 9th to 11th embodiments of a hinge, shown in FIGS. 19 to 24, the wire 2h to 2j with ball 2.2h to 2.2j is projected through a dirt guard 2.6 with sites of predetermined fracture “s” and through the hole of hinge pin 6h to 6j.

In the 9th embodiment both supporting arms 5.4h are secured by the heads of both round head rivets 5.5h, inserted into the retaining holes 5.31h of slide retainer 5.3h, sliding along a pair of surfaces 5.6h.

In the 10th to 11th embodiments (FIGS. 21, 23, 24) the hinge member 5.1i, 5.1j, slidable in or on the supporting arm 5.4i, 5.4j, is secured by retaining pin 25i, 25j with knurled head 25.1i, 25.1j, projected therein.

The rotatable connection of the mating hinge members 5.1h to 5.1j and 5.2h to 5.2j is ensured by the hinge pin 6h to 6j and the contact of both eyes of hinge member 5.2h to 5.2j with the supporting arms 5.4h or the supporting arm 5.4i, 5.4j and a pair of circular segments 5.7i, 5.7j of hinge member 5.1h to 5.1j. A round shape of retaining finger 5.41h improves the form-locking connection with the eye.

The range of door-opening is limited up to the position “O₃” when both surfaces comes in the contact with the contact surfaces Fa of both supporting arms 5.4h or the contact surface Fa of supporting arm 5.4i, 5.4j.

In the 9th embodiment the slide retainer 5.3h is, at first, removed by pulling the wire 20h, later on the pulling of wire 2h results in the fracture of the sites of predetermined fracture of the mud guard 2.6 and the removal of the hinge pin 6h from the hinge hole. Under load of “F_{1xy}” both supporting arms 5.4h with hinge member 5.2h rotate about the common axis of both rivets 5.5h from position “P₀” to “P₁”, shown in FIG. 20, thus resulting in the hinge detachment.

In the 10th and 11th embodiment the retaining pin 25i, 25j is removed by pulling the wire 21i, 21j. When pulling the wire 2iu, 2j the sites of predetermined fracture of the mud guard 2.6 are fractured and the hinge pin 6i, 6j is removed from the hinge hole. Finally, the supporting arm 5.4i, 5.4j is removed by pulling the wire 20i, 20j, thus resulting in the movement of the hinge member 5.2i, 5.2j, shown in FIG. 22, as well as the hinge detachment.

Taking the clearances for the operation of hinge detachment into consideration (FIG. 21) the wire 2iu of upper hinge 5i is joined to the wire 21i and the wire 20i, deflected by the deflecting pulley 30, by bracket 2.1i. Similarly, the wire 2io of the lower hinge is defined. Both united wires 2iu,2io, deflected by the respective deflecting pulleys 32a, 32b, are jammed together by bracket 2.3i to form a common wire 2, which is deflected by deflecting pulley 33 to a common wire 2, the tensile force “Z_{z}” of which is is greatly lowered in compliance with Eq. (6). Advantageously, only this single wire 2 must be pulled to detach the door from the vehicle body.

In the 1st embodiment of a gear G1, shown in FIGS. 12, 26, 36, the wire 2n, 2n is wound about the deflecting pulley 9. The tensile force “Zₙ” is governed by Eq. (3). To allow the wire to move in direction “Zₙ”, but not in direction “Zₜ”, it is retained by bracket 2.3a in front of a hole of member 10.2 of vehicle body and by bracket 2.3b in front of a hole of the member 10.3 of vehicle body, shown in FIG. 12. Instead of two a single bracket 2.3b can be used.

The wires 2n1 to 2nn of the door-release levers, in reference to the tensile forces “Zₙ₁” to “Znn”, are jammed together by bracket 2.3b. Upon the increase of the friction coefficient associated with surrounding the wires with hose 9.8, the tensile force “Zₙ” is greatly lowered in compliance with Eq. (5).

In the 2nd embodiment of a gear G2 shown in FIG. 13 the retaining ball 2.4 of wire 2n is inserted into a hole of the first deflecting pulley 9.1a with radius “f” and the retaining ball 2.5 of wire 2n is inserted into a hole of the second deflecting pulley 9.2a with radius “r₂”, where r₂>r₁ is. The tensile force 37 Zₙ” is governed by Eq. (5).

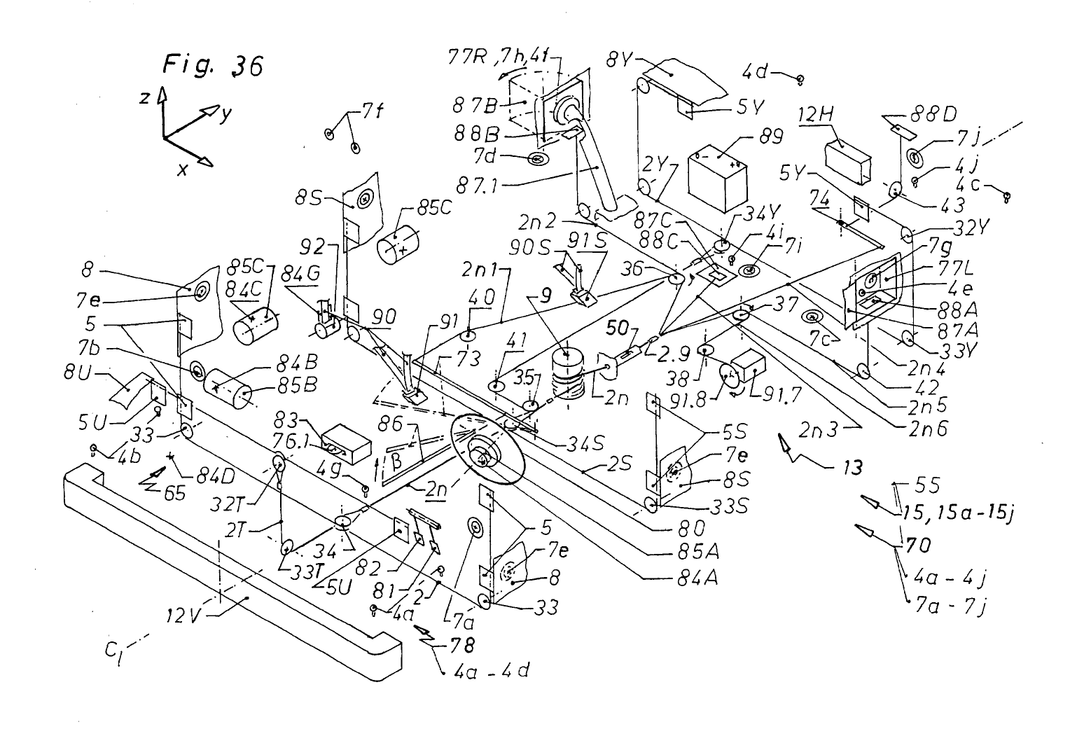

In the 3rd embodiment of a gear G3 in conjunction with the 1st embodiment of a door-release lever, shown in FIGS. 25, 36, a pipe 73.1 serves as a swinging arm 73, 74, to the first end of which a threaded pin 73.2 is fastened and to the second end an eye screw 73.4. To adjust the reduction-ratio the wire ring 86.6 of wire 2n1, deflected by deflecting pulley 40, is positioned along the threaded pin 73.2 and the wire ring 86.7 of auxiliary wire 86.2 is positioned along the eye screw 73.4. Later on, both wire rings are secured by tightening two pairs of nuts 73.3, 73.5, respectively. The auxiliary wire 86.2 is jammed to the brake wire 86.3 by bracket 86.4. Upon insertion of a retaining pin 86.5 in the back portion of the hand-brake lever 86 the brake wire, deflected by deflecting pulley 86.1, is connected thereto. When the freewheeling device 50, 50a is in the state of lock (non-freewheeling), the rotation of hand-brake lever 86 up to the angle “β” results in the dual operation “hand braking and door detachment”.

To resolve the problem of U.S. Pat. No. 5,011,215, whose feature facilitates thefts and children to detach locked doors, the above-mentioned gear G1, G2 is equipped with an undermentioned freewheeling device 50, 50a to 50b or a latch device, shown in FIGS. 12 and 13, having a blocking shaft 11, longitudinally movable in the outer tube 11.1, which is inserted into a hole on the front surface of deflecting pulley 9, 9.1a, 9.2a, when the gear is locked, or pulled out of which, when the gear is disengaged.

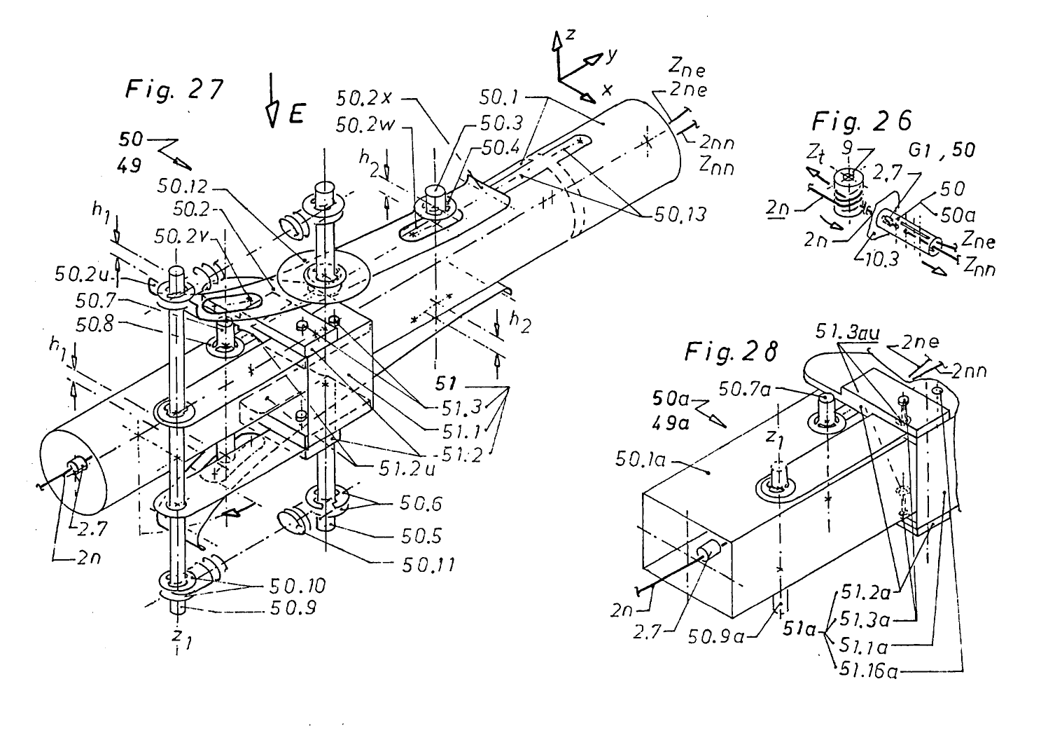

In the 1st to 3rd embodiment of the freewheeling device 50, 50a to 50b, shown in FIGS. 26 to 32, 36 comprises a distributor 49, 49a to 49b and a coupling casing 51, 51a to 51b, provided with a motor 51.5 (not drawn). In the distributor the entrance wire 2n is attached to the main exit wire 2nn or detached therefrom, where the main exit wire 2nn and complementary exit wires are jammed together to from exit wires 2n1 to 2nn by bracket 2.9.

The wire 2n is wound around the shaft 50.7. The end portion thereof is jammed to the wire portion by bracket 2.8. To allow the wire to move in direction “Zₙ”, but not in direction “Zₜ”, it is retained by bracket 2.7 or 2.3b in front of the hole of member 10.3 of the vehicle body, shown in FIGS. 12, 26. In another embodiment without bracket 2.8, the bracket 2.7, shown in FIG. 32, takes over this task.

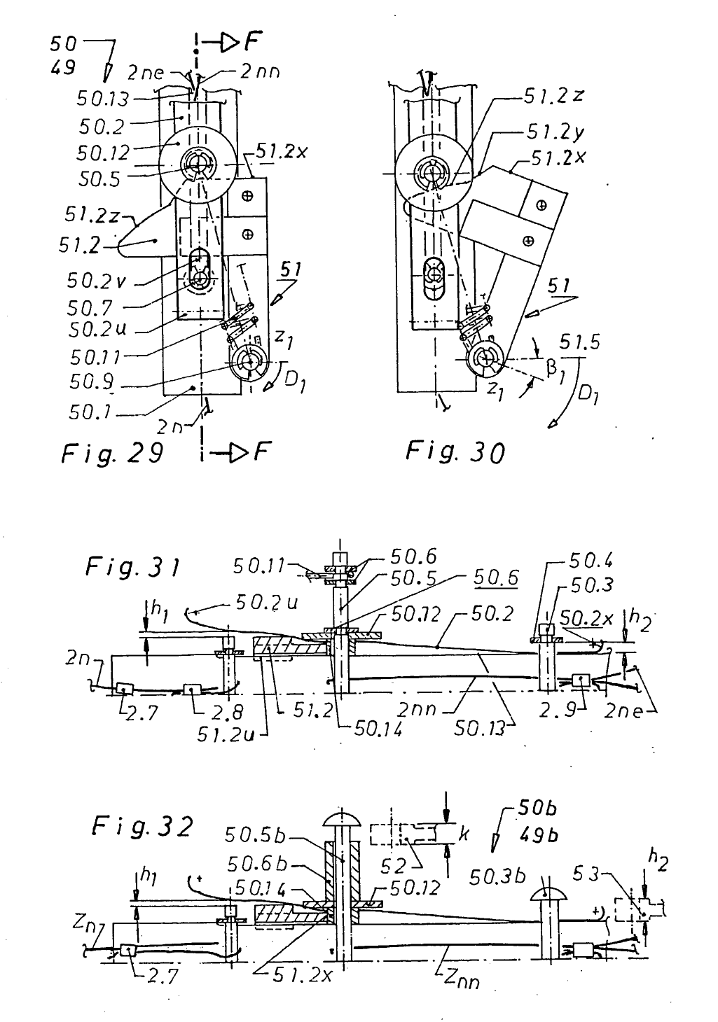

In the 1st embodiment of the freewheeling device, shown in FIGS. 26, 27, 29 to 31, 36, the coupling casing 51 comprises a pair of control plates 51.2, provided with control edges 51.2x to 51.2z, and a U-shaped holder 51.1, force-locking connected to the control plates by four rivets 51.3. A pair of round retaining segments 51.2u of coupling casing 51 is form-locking retained on the tube 50.1. Upon the rotation of motor 51.5, switched on in an accident, the retaining segments 51.2u are disconnected from tube 50.1 and the coupling casing 51 rotates about the z₁-axis of shaft 50.9, welded to the tube, in rotating direction “D₁”, shown in FIG. 27, 29. Upon the increase of the rotation of the coupling casing the control edges 51.2z make contact with the spacers 50.14 thereby reducing the height of the oblong holes 50.2v of both leaf springs. Upon rotation up to angle “β”, shown in FIG. 30, both end portions of shaft 50.7 are engaged with the oblong holes 50.2v, thus locking the freewheeling device. Upon further rotation of the round retaining segments 51.2u the shafts 50.3, 50.5, 50.7 are moved along the pairs of oblong holes 50.13 of tube 50.1 of distributor 49 in y-direction by pulling the wire 2nn, thus resulting in the door detachment.

The end portions of shaft 50.7 of wire 2n, protruding through the oblong holes 50.13, are secured by two retaining rings 50.8.

The end portions of shaft 50.5, protruding through the oblong holes 50.13 and the holes of leaf springs 50.2, are secured by a pair of spacers 50.14, a pair of big washers 50.12 and a pair of retaining rings 50.6, similar to 50.6 shown in FIG. 31. The end portions of shaft 50.3, protruding to through the oblong holes 50.13 and the oblong holes 50.2w of leaf springs 50.2, are secured by retaining rings 50.4. A pair of springs 50.11, rotatably attached to the shaft 50.9, biases the shaft 50.7, so that the spacers 50.14 are in contact with the control edges, the biased leaf springs 50.2, in contact with the control plates 51.2, lie over the ends of shaft 50.7 about the height “h₁” and the freewheeling device 50 is in the slate of non-lock. The tensioning force of the leaf spring depends on the height difference “h₂”.

Owing to the round end portions 50.2u, 50.2x the leaf springs 50.2 smoothly move along the tube.

In the 2nd embodiment of the freewheeling device, shown in FIG. 28, the coupling casing 51a comprises a pair of control plates 51.2a, provided with control edges, and a U-shaped holder 51.1a, force-locking connected to the control plates by two pairs of round head rivets 51.3a and countersunk rivets 51.16a. When the freewheeling device 50a is disengaged, the retaining heads 51.3au of both round head rivets are in plug-in connection with the holes of rectangular tube 50.1a.

In the 3rd embodiment of the freewheeling device 50b, shown in FIG. 32, manufacturing costs of the distributor 49b are enormously cut by the use of both tools 52, 53, inserted between two round head rivets 50.3b, 50.5b, by a pair of spacers 50.6b to maintain the height differences “hₜ” and “h₂” and by the use the remaining members of freewheeling device 50. Afterwards the tools are removed.

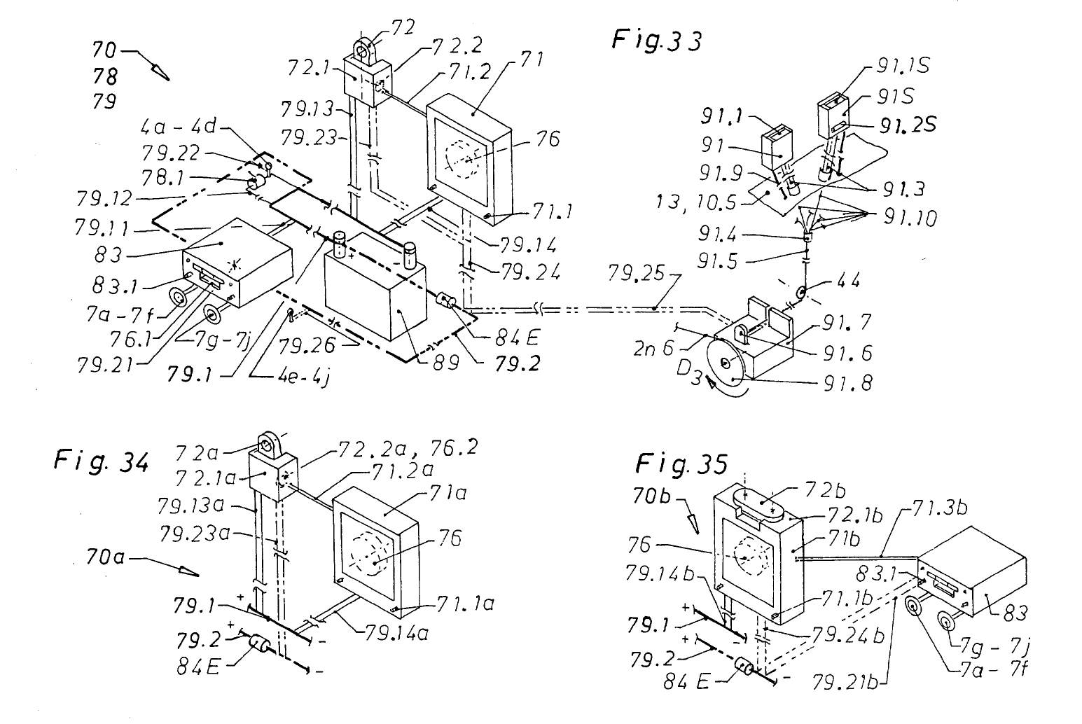

In the 2nd and 3rd embodiment of the door-release lever, shown in FIG. 33 to 36, the press buttons 91.2, 91.2S differ from the release buttons 91.1, 91.1S which must always be depressed, when passengers want to step out, and helps them, under shock in an accident or a fire, rescue themselves. Preferably, the release cable 91.3 is a member of belt pretensioner 91.9, fastened to the mid-tunnel 10.5 or vehicle floor 13. The wires 91.10 of all release cables 91.3 are jammed together by bracket 91.4 and united to a wire 91.5, connected to the switch 91.6 of electrical motor 91.7.

In the 1st to 3rd embodiment of a warning system 70, 70a, 70b, shown in FIGS. 33 to 36, the function of the standard vehicle parts such as radio, warning device, navigator and cell phone are supplemented and adapted to the warning system in order to save costs and R&D work. The warning device 78, comprising wanting lights 4a to 4d and a switch 78.1, is supplemented with warning lights 4e to 4n and a second current circuit 79.22 in order to serve as a visible warning system for drivers of oncoming vehicles, rescue workers as well as passengers.

All current circuits are protected against overload by fuses, in a not drawn fuse box. A minor current circuit 79.2, the major current circuits 79.11 to 79.14 of radio 83, navigator (navigational device) 71, cell phone 72, warning device 78, comprising warning lights 4a to 4d and switch 78.1, current circuits 79.1a to 79.1d, 79.1f to 79.1h (not drawn) of sensors 84A to 84D, 84F to 84H, current circuit 79.1e as well as of other current circuits (not drawn) are connected to a main current circuit 79.1, shown in FIG. 33. In order to prevent fire in accidents, the power supply to the pump of the fuel tank and fuel injection apparatus is cut off. The power supply is ensured by the minor current circuit 79.2, which is supplied with current by at least one sensor 84A to 84H activated in an accident and/or a fire and to which the secondary current circuits 79.21 to 79.26 of radio 83, navigator 71, cell phone 72, motor 91.7, warning lights 4e to 4n and warning lights 4a to 4d of warning device 78 are connected. Independent of whether both switches 83.1, 78.1 of radio 83 and of warning device 78 are turned on or off in an accident and/or a fire, the text data 69, stored in a storage medium 76, 76.1, is played back via the loudspeakers 7a to 7n and all warning lights 4a to 4n flash, thus facilitating the passengers and/or rescue workers to find the door-release levers and the vehicle, particularly when it is dark, and to operate the levers. The loudspeakers 7a, 7b are located in the dash board (not drawn), loudspeakers 7c, 7d in the wall (not drawn), separating the passenger compartment from the trunk compartment, loudspeakers 7e in the vehicle doors 8, 8S, loudspeakers 7f in the head rests (not drawn), loudspeakers 7g, 7h in the tank-spaces 77L, 77R, loudspeaker 7i on the vehicle floor 13 and to loudspeaker 7j in the trunk compartment. Beyond doubt, the loudspeakers of another device such as cell phone 72, 72a, 72b, navigator 71, 71a, 71b and/or dictaphone (not drawn) can also be put into use.

Foreign passengers and/or foreign rescue workers can perceive the text data 69, containing

“position and operation (pulling or depressing) of the door-release levers” and “way to the emergency doors of car, aeroplane or ship”

in several languages, stored in a storage medium 76, 76.1, 76.2. The basic text data 69 can be supplemented and amended. This storage medium, prefabricated, can be offered for sale. The repetition of the text data 69 can be terminated by operation of a switch (not drawn) or in excess of a time limit.

Because the storage medium 76, 76.2 is a part of navigator 71b and cell phone 72, 72a, 72b extra costs for enlarging the storage capacity and for programming are low. The space-saving storage medium 76.2 of cell phone 72b offers sufficient storage capacity for the text information. In the 1st embodiment of the warning system 70, shown in FIGS. 33 to 36, the sensor 84F, supplied with current of the current circuit 79.1e, is activated in an accident so that current flows in the current circuits 79.21 to 79.24 of radio 83, cell phone 72, navigator 71 and warning device 78.

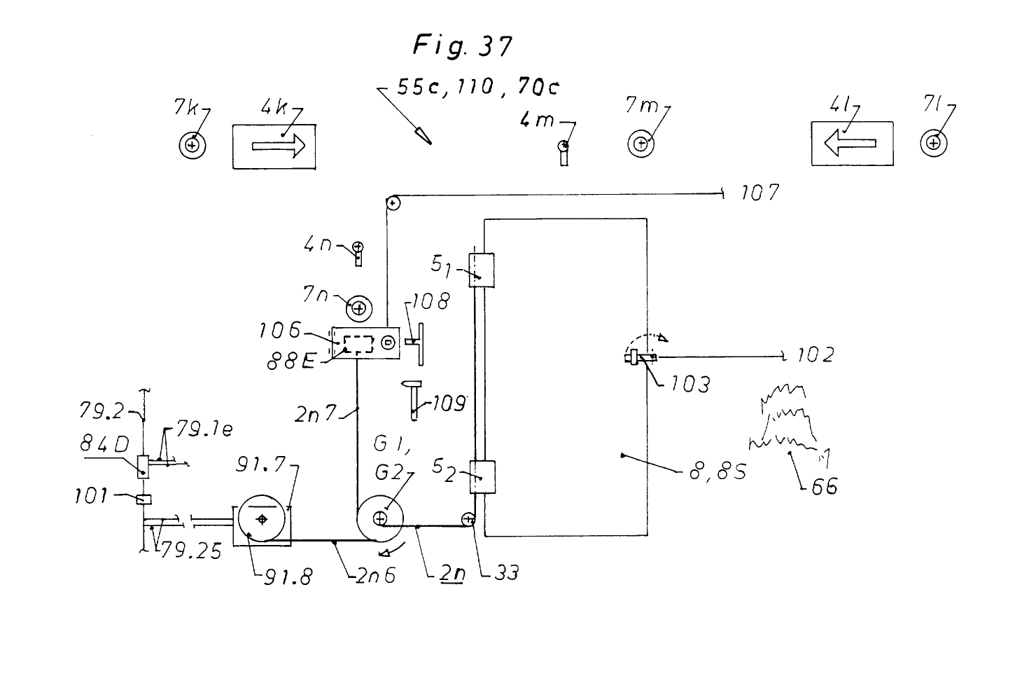

The text data 69, stored in the storage medium 76, 76.1 to 76.2, is played back by the radio 83 via its own loudspeakers 7a to 7n and/or by the cell phone 72 via its over loudspeaker. Independent of whether the switch 78.1 is turned on or off, all walking lights 4a to 4n of warning device 78 are supplied with current of the current circuit 79.22. The conventional warning lights 4a to 4d are located at the four outer edges of vehicle or transport system and the warning lights 4e to 4n are positioned adjacent to the hand-brake lever 86 and door-release levers 88A to 88E, shown in FIGS. 36 to 37.

In the 2nd embodiment of a warning system 70a, equipped with the radio 83, shown in FIG. 34, the current circuit 79.13a of cell phone 72a as well as the current circuit 79.14a of navigator 71a are connected to the main current circuit 79.1 and the current circuit 79.23a of cell phone 72a is connected to the minor current circuit 79.2.

To cut costs the radio 83 has no storage medium. In an accident an electromagnetic (solenoid) switch 72.1a of cell phone 72ais activated to enable data transmission via the wire 71.2a. Hence, the cell phone 72a receives the text data 69 from the storage medium 76 of navigator 71 and plays it back via its own loudspeaker. Alternately, the cell phone 72a can immediately play back the text data 69 from its own storage medium 76.2 via its own loudspeaker.

In the 3rd embodiment of a warning system 70b, shown in FIG. 35, the current circuit 79.14b of navigator 71b is connected to the main current circuit 79.1 and the other current circuit 79.24b is connected to the minor current circuit 79.2. In an accident an electromagnetic switch 72.1b of navigator 71b is activated to enable data transmission to the cell phone 72b and to the radio 83 via the wire 71.3b. Hence, the transmitted text data 69 from the storage medium 76 of navigator 71b is played back via the loudspeaker of cell phone 72b and the loudspeakers 7a to 7n of radio 83.

In the 1st embodiment of a warning system 55, shown in FIG. 36, a united wire 2n is defined by the wires 2, 2S, 2U, 2Y of vehicle doors 8, 8S, hood 8U, trunk cover 8Y in association with the respective pivots 34, 34S, 33T, 34Y, 41, 35 and brackets. This wire 2n is wound about the deflecting pulley 9 of gear G1 where the exit wire 2n of which serves as an entrance wire of the freewheeling device 50. The exit wire 2nn of the freewheeling device 50 is branched from the bracket 2.9 to the following wires of door-detachment device 15, 15a to 15j of transport system wire 2n1 of hand-brake lever 86 upon the use of pivots 36, 40 and swinging arm 73, wire 2n2 of door-release lever 88B upon the use of pivots 36, 42, wire 2n3 of door-release lever 88C on the vehicle floor, wire 2n4 of door-release lever 88D upon the use of swinging arm 74 and pivot 43, wire 2n5 of door-release lever 88A upon the use of pivots 37, 42 and wire 2n6 of release buttons 91.1 and/or push buttons 91.2S upon the use of pivots 37, 38, 44 and belt pulley 91.8 driven by motor 91.7.

When the sensors 84A to 84H is provided with a conventional time-lag (dwell-time) relay, which is responsible for the time-lag between the start and end of the accident, current flows in the motor 91.7 in excess thereof. Without activating the switch 91.6 the motor 91.7 self-starts the door-detachment device 15, 15a to 15j.

In the 2nd embodiment of the rescue system 55a the freewheeling device 50 is replaced by the latch device of gear G1, G2 while the remaining parts of rescue system 55 are put into use.

In the 3rd embodiment of the rescue system 55c without freewheeling device independent door-detachments are mounted to the doors 8, 8S and emergency doors of ship, bus or aeroplane due to long distance of the doors to each other (FIG. 37). If the wires 102, to operate and/or to open the door, are destroyed by fire, the door locks 103 of the doors 8, 8S remain locked and the passengers, being shut in, will be burned. Such tragedy is prevented by an independent door-detachment comprising a door-release lever 88E, the entrance wire 2n of door hinges 5₁ and 5₂, gear G2, motor 91.7 equipped with belt pulley 91.8, the exit wires 2n6, 2n7 and a fire-control 110, which consists of the temperature-sensor 84D to sense fire 66 and a speedometer (tachometer) 105 (not drawn) or a time-lag relay 101. When the transport system comes to a halt after the accident, the speedometer 105 in co-operation with the sensor 84D releases current so that the belt pulley 91.8 of motor 91.7 pulls the exit wire 2n6. The speedometer 105 can be replaced by time-lag relay 101. Car battery 89 is or rechargeable batteries 89a are provided for power supply.

The door-release lever 88E can be operated when the current wires 79.1e, 79.2, 79.25 are destroyed too by the fire 66. A protective cover 106 protects the door-release lever 88E from misuse. The cover 106 is opened by a motor 104 (not drawn), activated by sensor 84D, or by a wire 107, pulled by the captain, or by a tool (plug-in tool) 108. If it does not work at all, in emergency case it is crushed into pieces by a pick-hammer.

Via the warning lights 4k to 4n and the loudspeakers 7k to 7n of the visible and audible warning system 70c the passengers are instructed to rush to the door and operate the door-detachment device.

This 3rd embodiment is suited too for trains and motor vehicles such as buses. Although the present invention has been described and illustrated in detail, it is clearly understood that the terminology used is intended to describe rather than limit. Many more objects, embodiments, features and variations of the present invention are possible in light of the above-mentioned teachings. Therefore, within the spirit and scope of the appended claims, the present invention may be practised otherwise than is specifically described and illustrated.

1. A rescue system for a transport system, to the vehicle body (10) of which at least one vehicle door (8, 8S to 8Y), generally representing a vehicle door (8, 8S), tailgate door (8T), hood (8U), cargo-, liftgate-, revolving door (8V), double cargo door (8W), sliding door (8X) or trunk cover (8Y), is hingedly mounted for alternately covering and uncovering a door opening through the vehicle body, is equipped with a door-detachment device comprising:
at least two hinges (5), each of which comprises a hinge vehicle-door member (5.2), fastened to the vehicle door (8, 8S to 8Y), a hinge vehicle-body member (5.1), fastened to the vehicle body (10), and a removable hinge pin (6), where a lower and upper portion of the lower hinge pin and a lower portion of the upper hinge pin, each protrudes through the hole of the respective hinge and is provided with a hole; and
a common tie member (2), connected to the hole of the lower protruding portion of the lower hinge pin, the hole of the upper protruding portion of which is connected to the hole of the lower protruding portion of the upper hinge pin by a connecting tie member (2ₒ);
where the vehicle door (8, 8S to 8V), which is jammed in the vehicle body (10) by impact energy in an accident or remains locked due to fire, is detached therefrom in response to a removal of both hinge pins (6), pulled by the common tie member (2), from the hole of the corresponding hinges (5).

2. A rescue system for a transport system, to the vehicle body (10) of which at least one vehicle door (8, 8S to 8Y), generally representing a vehicle door (8, 8S), tailgate door (8T), hood (8U), cargo-, liftgate-, revolving door (8V), double cargo door (8W), sliding door (8X) or trunk cover (8Y), is hingedly mounted for alternately covering and uncovering a door opening through the vehicle body, is equipped with a door-detachment device comprising:
at least two hinges (5a to 5f), each of which comprises a hinge vehicle-door member (5.2a to 5.2f), fastened to the vehicle door (8, 8S to 8Y), a hinge vehicle-body member (5.1a to 5.1f), consisting of a hole and two hinge legs (5.11a to 5.11f; 5.12a to 5.12f), one of which is fastened to the vehicle body (10), and a removable hinge pin (6a to 6f), having a longitudinal hole;
a common tie member (2a to 2c), one end of which is fastened to an upper ball (2.2a to 2.2c), having a diameter larger than that of the longitudinal hole, and the other end is projected down through the longitudinal hole of the upper hinge pin, till the upper ball comes in contact with upper surface thereof, through a lower ball (2.2a to 2.2c) and then the longitudinal hole of the lower hinge pin, with the upper surface of which the lower ball is in contact and fastened thereto;
expanding pieces (3a to 3f), each of which, having at least one hole, is arranged between both hinge legs (5.11a to 5.11f; 5.12a to 5.12f) and biased thereby;
a lead tie member (20a, 20c, 2b to 2f), connected to the hole of the lower expanding piece, which is connected to the hole of the upper expanding piece by an auxiliary tie member;
soundproofing materials (3.5a to 3.5f), surrounding surfaces of the expanding piece in contact with both hinge legs to silence noises; and
at least one catch member (1,1d), loosely connecting the hinge vehicle-door member to the hinge vehicle-body member to prevent the vehicle door (8, 8S to 8Y), which, when detached, from flying off;
where the vehicle door (8, 8S to 8Y), which is jammed in the vehicle body (10) by impact energy in an accident or remains locked due to fire, is detached therefrom when both expanding pieces, pulled by the lead tie member, expand both hinge legs of the corresponding vehicle-body hinge members as well as the hole thereof and, finally, both hinge pins, pulled by the common tie member (2), are detached from the hole of the corresponding hinges.

3. A rescue system for a transport system, to the vehicle body (10) of which at least one vehicle door (8, 8S to 8Y), generally representing a vehicle door (8, 8S), tailgate door (8T), hood (8U), cargo-, liftgate-, revolving door (8V), double cargo door (8W), sliding door (8X) or tank cover (8Y), is hingedly mounted for alternately covering and uncovering a door opening through the vehicle body, is equipped with a door-detachment device comprising:
at least two hinges (5a to 5f), each of which comprises a hinge vehicle-door member (5.2a to 5.2f), fastened to the vehicle door (8, 8S to 8Y), a hinge vehicle-body member (5.1a to 5.1f), consisting of a hole and two hinge legs (5.11a to 5.11f; 5.12a to 5.12f), one of which is fastened to the vehicle body (10), and a hinge pin (6a to 6f);
a pair of sites of predetermined fracture, arranged on the upper and lower surface of the hinge vehicle-body member (5.1a to 5.1f);
expanding pieces (3a to 3f), each of which, having at least one hole, is arranged between both hinge legs (5.11a to 5.11f; 5.12a to 5.12f) and biased thereby;
soundproofing materials (3.5a to 3.5f), surrounding surfaces of the expanding piece in contact with both hinge legs to silence noises; and
a common tie member (20a, 20c, 2b to 2f), connected to the hole of the lower expanding piece, which is connected to the hole of the upper expanding piece by an auxiliary tie member;
where the vehicle door (8, 8S to 8Y), which is jammed in the vehicle body (10) by impact energy in an accident or remains locked due to fire, is detached therefrom by a fracture of the sites of predetermined fracture resulting from an expansion of both hinge legs of the corresponding vehicle-body hinge members as well as the hole thereof by the respective expanding pieces, pulled by the common tie member.

4. A rescue system for a transport system, to the vehicle body (10) of which at least one vehicle door (8, 8S to 8Y), generally representing a vehicle door (8, 8S), tailgate door (8T), hood (8U), cargo-, liftgate-, revolving door (8V), double cargo door (8W), sliding door (8X) or trunk cover (8Y), is hingedly mounted for alternately covering and uncovering a door opening through the vehicle body, is equipped with a door-detachment device comprising:
at least two hinges (5g), each of which comprises a hinge vehicle-door member (5.2g), fastened to the vehicle door (8, 8S to 8Y), a U-shaped hinge vehicle-body member (5.1g), provided with an upper and lower hinge-pin flange (5.1go, 5.1gu) and an upper and lower guide-tube flange (5.1go, 5.1gu) and fastened to the vehicle body (10), and a hinge pin (6g);
a pair of two hinge-pin members (6go, 6gu), each of which defines the hinge pin (6g), is force-locking connected to a pair of guide tubes (6.5o, 6.5u), each of which telescopes into the other in z-direction, by two coupling members (6.1o, 6.1u), connected to each other
by a form-locking connection of the hinge-pin members (6go, 6gu) with a hole of the upper and lower hinge-pin flange (5.1go, 5.1gu) and of the upper guide tubes (6.5o) with a hole of the upper and lower guide-tube flange (5.1o, 5.1gu) and
by a pair of upper swinging arms (6.2o) and of lower swinging arms (6.2u), both rotatably connected to a common slide shoe (6.4), in form- and force-locking connection with a common tie member (2g), which, arranged in the hinge vehicle-body member (5.1g), is movable in y-direction and the longitudinal of which is limited by a stop ring (2.1g); and
at least one catch member (1, 1d), loosely connecting both hinge members (5.1a to 5.1f; 5.2a to 5.2f) to prevent the vehicle door (8, 8S to 8Y), when detached, from flying off;
where the vehicle door (8, 8S to 8Y), which is jammed in the vehicle body (10) by impact energy in an accident or remains locked due to fire, is detached therefrom by pulling the common tie members (2g), which pushes the pairs of upper swinging arms (6.2o) upwardly and the pairs pair of lower swinging arms (6.2u) downwardly, thus detaching the hinge vehicle-door members (5.2g) from the pairs of hinge-pin members (6go, 6gu), respectively.

5. A rescue system for a transport system, to the vehicle body (10) of which at least one vehicle door (8, 8S to 8Y), generally representing a vehicle door (8, 8S), tailgate door (8T), hood (8U), cargo-, liftgate-, revolving door (8V), double cargo door (8W), sliding door (8X) or trunk cover (8Y), is hingedly mounted for alternately covering and uncovering a door opening through the vehicle body, is equipped with a door-detachment device comprising:
at least two hinges (5i), each of which comprises a hinge vehicle-door member (5.2i), fastened to the vehicle door (8, 8S to 8Y), an L-shaped hinge vehicle-body member (5.1i), fastened to the vehicle body (10), and a hinge pin (6i), having a longitudinal hole;
two eyes of the hinge vehicle-door member (5.2i), which are in form-locking connection with circular segments (5.7i) of the hinge vehicle-body member (5.1i) and with a protruding portion of a supporting arm (5.4i), slidable in the hinge vehicle-body member (5.1i) and secured by a retaining pin (25i) with a knurled head (25.1i), inserted into the hinge vehicle-body member and supporting arm;
two hinge wires (2iu, 2io), ends of which are provided with balls, whose diameter is larger than that of the longitudinal hole,
the other end of the upper hinge wire is downwardly projected through the longitudinal hole of the upper hinge pin (6i), till the ball comes in contact with the upper surface thereof, to which a wire (21i) of the retaining pin (25i) and a wire (20i) of the supporting arm (5.4i), deflected by a deflecting hinge-pulley (30), are clamped by a bracket (2.1i), and
the other end of the lower hinge wire is upwardly projected through the longitudinal hole of the lower hinge pin (6i), till the ball comes in contact with the lower surface thereof, to which a wire (21i) of the retaining pin (25i) and a wire (20i) of the supporting arm (5.4i), deflected by a deflecting hinge-pulley (30), are clamped by a bracket (2.1i),
where both hinge wires with a number of turns (iₐ) and (i_{b}), deflected by a twin-deflecting pulley (32), join together by means of a bracket (2.3i) as a lead wire (2);
a deflecting door-pulley (33), deflecting the lead wire (2) with a number of turns (i_{c}) into a common tie member (2); and
at least one catch member (1, 1d), loosely connecting both hinge members (5.1a to 5.1f; 5.2a to 5.2f) to prevent the vehicle door (8, 8S to 8Y), when detached, from flying off;
where the vehicle door (8, 8S to 8Y), which is jammed in the vehicle body (10) by impact energy in an accident or remains locked due to fife, is detached therefrom by puffing the common tie member (2), which pulls both hinge pins (6i) out of the hole of the respective hinges, retaining pins (25i) out of the respective supporting arms (5.4i) and hinge vehicle-body members and moves the protruding portions of the supporting arms (5.4i) into the hinge vehicle-body member, thus facilitating the hinge vehicle-door members, under load of the impact energy, to detach from the corresponding hinges by themselves.

6. A rescue system according to claim 2, wherein the rotatory expanding piece (3e to 3f), located between both hinge legs (5.11e to 5.11f; 5.12e to 5.12f), is secured by a retaining pin (3.1e, 3.2f) projected therein and bolted to the hinge leg (5.12e, 5.12f).

7. A rescue system according to claim 6, wherein that both hinge legs (5.11a to 5.11f; 5.12a to 5.12f) are expanded by the expanding wheel (3f), having a side with slope angle (oeₒ), upon rotatory movement thereof.

8. A rescue system according to claim 2, wherein the expanding piece (3b) consists of
a first cylindrical member (3.1b), a main portion of which is located on two cylindrical surfaces of both hinge legs and a protruding portion of which is provided with a lower hole;
a conical member (3.2b) and
a second cylindrical member (3.4b) with length of (Lₘ) and an upper hole,
where the auxiliary tie member connects the lower hole of the upper expanding piece to the upper hole of the lower expanding piece, to the lower hole of which the common tie member, replacing the lead tie member, is loosely connected, where in response to the pulling of the common tie member the conical members of the expanding pieces expand the hinge legs of the corresponding vehicle-body hinge members and, later on, the second cylindrical members thereof start to move therein and, simultaneously, the hinge pins stall to move out of the hole of the corresponding hinges and become detached therefrom owing to the length of (Lₙ) smaller than (Lₘ).

9. A rescue system according to claim 2, wherein the expanding piece (3a) consists of
a cylindrical member (3.1a), a main portion of which is located on two cylindrical surfaces of both hinge legs and a protruding portion of which is provided with a hole;
sites of predetermined fracture arranged to the hole; and
a conical member (3.2a) with a stop ring (3.3a);
where the auxiliary tie member connects the hole of the upper expanding piece to the hole of the lower expanding piece, to which the common tie member, replacing the lead tie member, is loosely connected, where the common tie member pulls the expanding pieces along the cylindrical surfaces of the corresponding hinge legs, which are expanded by the conical members until their stop rings are blocked by the upper surfaces of the respective hinges, and, finally, detaches the hinge pins from the hole of the hinges, respectively.

10. A rescue system according to claim 9, wherein the rescue system consists of a number of independent door-detachment devices (15, 15a to 15j), each of which is provided with a gear (G1), comprising
an entrance tie member (2n), which is the common tie member, deflected by entrance-member pivots of the transport system;
a first and second exit tie member (2n6, 2n7);
a deflecting pulley (9) with radius (r), about which the exit tie members are wound a number of turns (i)
a belt pulley (91.8), driven by a motor (91.7) and connected to the first exit tie member (2n6); and
a door-release lever (88E), arranged adjacent to the vehicle door (8, 8S to 8Y), connected to the second exit tie member (2n7) and protected from misuse by a protective cover (106).

11. A rescue system according to claim 10, further comprising at least one crash sensor (84A to 84H), which in the event of an accident releases current to the motor (91.7), which, when the transport system comes to a halt, activates the door-detachment device to automatically detach the vehicle door (8, 8S to 8Y) from the vehicle body (10).

12. A rescue system according to claim 10, further comprising at least one crash sensor (84A to 84H) and a fire sensor, one of which in the event of an accident or fire releases current to the motor (91.7), which, when the transport system comes to a halt, activates the door-detachment device to automatically detach the vehicle door (8, 8S to 8Y) from the vehicle body (10).

13. A rescue system according to claim 10, wherein the protective cover (106) is opened by an independent motor (104), activated by a sensor (84D).

14. A rescue system according to claim 10, wherein the protective cover (106) is opened by pulling a tie member (107).

15. A rescue system according to claim 3, wherein the hinge vehicle-body member (5.1a to 5.1f) with both hinge legs (5.11a to 5.11f; 5.12a to 5.12f) is made of a casting component.

16. A rescue system according to claim 3, wherein the hinge vehicle-body member (5.1a to 5.1f) with both hinge legs (5.11a to 5.11f; 5.12a to 5.12f) is made of an extrusion component.

17. A rescue system according to claim 16, wherein a doorstop, which is integrated in the door-detachment device, comprises
a doorstop retainer (1.2d), which is provided with cut-outs and a tension spring (1.3d), fastened to the hinge vehicle-door member (5.2d) by two pins (1.4d);
a catch pin (1d), provided with a downward-directed portion (1.6d) and projecting through an aperture of the hinge vehicle-door member, the first hinge leg (5.11d) and the expanding piece (3e), whose rim has an increasing thickness (tᵢ), bolted to the second hinge leg (5.12d), fastened to the vehicle body and to a nut (1.1d); and
two stop pins (5.3d), each of which is arranged on the upper and lower surface of the hinge vehicle-body member (5.1d) to stop the vehicle door opening too far;
where the catch pin, when vehicle door is opened, moves out of the aperture of the hinge vehicle-door member and the downward-directed portion (1.6d) thereof engages in one of the cut-outs of the doorstop retainer, biased by the tension spring, in a position of (O₁), (O₂) or (O₃) to keep the vehicle door open, and
where the door-detachment device, when operated, detaches the vehicle doors (8, 8S to 8Y), jammed in the accident or remaining locked due to fire, each of which, restrained by the catch pin to prevent from flying off is released by pressing in the tension spring as well as the doorstop retainer out of the catch pin.

18. A rescue system according to claim 17, wherein a reduction gear (G2) comprises
an entrance tie member (2n), into which the common tie members of the vehicle doors, deflected by entrance-member pivots of the transport system, are merged;
an exit tie member (2n);
a deflecting pulley (9a), consisting of
a first deflecting pulley (9.1a) with small radius (r₁), into a retaining hole of which a retaining ball (2.4) of the entrance tie member (2n) is projected and, finally, about which the entrance tie member (2n) is wound a number of turns (i₁); and
a second deflecting pulley (9.2a) with big radius (r₂) larger than (r₁), into a retaining hole of which a retaining ball (2.5) of the exit tie member (2n) is projected and, finally, about which the exit tie member (2n) is wound a number of turns (i₂);
hoses (9.8), surrounding portions of the tie members, deflected by the deflecting pulleys and wound thereabout; and
a bracket (2.3a), clamped around the entrance tie member (2n), in front of a hole of a member (10.2) of the vehicle body, and a bracket (2.3b), clamped around the exit tie member (2n), in front of a hole of a member (10.3) thereof to prevent a movement of the tie member in direction (Zₜ) and to allow the movement thereof in direction (Zₙ).

19. A rescue system according to claim 18, wherein a freewheeling device (50) comprises a distributor (49), consisting of
an entrance tie member, which is the exit tie member (2n) of the reduction gear (G2), wound around a shaft (50.7) and clamped together by a bracket (2.9), and a main exit tie member (2nn), wound around two shafts (50.3, 50.5), which together with complementary exit tie members (2n1 to 2nm), jammed by a bracket (2.9), are connected to door-release levers (86, 88A to 88D, 91.1, 91.2S) of the door-detachment device (15);
a pair of leaf springs (50.2), each of which has round end portions (50.2u, 50.2x), a hole, a first and second oblong hole (50.2v, 50.2w);
a tube (50.1), having a pair of oblong holes (50.13), along which three shafts (50.3, 50.5, 50.7) are movable in longitudinal direction thereof,
the first shaft (50.7), end portions of which, protruding through the pair of oblong holes of the tube (50.1) and secured by two retaining rings (50.8), are detached from the first oblong hole of the corresponding leaf springs in a non-lock state of the freewheeling device;
the second shaft (50.5), end portions of which, protruding through the oblong holes (50.13) of the tube (50.1) and the hole of the corresponding leaf springs (50.2), are secured by a pair of spacers (50.14), a pair of big washers (50.12) and a pair of retaining rings (50.6);
the third shaft (50.3), end portions of which, protruding through the oblong holes (50.13) of the tube (50.1) and the second oblong hole (50.2w) of the corresponding leaf springs (50.2), are secured by a pair of retaining rings (50.4); and
a fourth shaft (50.9), force-locking connected to the tube, to pivot a coupling casing (51) and to receive a pair of springs (50.11), biasing the first shaft (50.7);
the coupling casing (51), consisting of
a pair of control plates (51.2), having control edges (51.2x to 51.2z) and a pair of round retaining segments (51.2u); and
a U-shaped holder (51.1), plug-in and force-locking connected to the control plates (51.2) by four rivets (51.3); and
a motor (51.5);
where, when the coupling casing (51) is coupled with the distributor (49) by a form-locking connection of the round retaining segments (51.2u) with the tube (50.1), the freewheeling device (50) is in the state of non-lock, which is changed into a state of lock by engaging the end portions of the first shaft (50.7) to the first oblong hole of the corresponding leaf springs in response to the separation of the coupling casing (51), being rotated up to angle (β₁) by the motor (51.5) activated in the accident, from the distributor (49).

20. A rescue system according to claim 19, wherein a hand-brake lever (86), serving as the door-release lever, is provided with a dual-operation gear (G3) having a swinging arm (73), rotatable about the z₂-axis, comprising
a hand-brake tie member (86.2), one end of which is fastened to a hand-brake wire (86.3) of the hand-brake lever (86) by a bracket (86.4) and the other end is fastened to a second ring (86.7);
a pipe (73.1), to one end of which a threaded pin (73.2) is fastened and to the other end an eye screw (73.4) is fastened, where the reduction-ratio is adjusted by moving a first ring (86.6) of the complementary exit tie member (2n1), deflected by exit-member pivots of the transport system, along the threaded pin (73.2) and the second ring (86.7) of the hand-brake tie member (86.2) along the eye screw (73.4); and
two pairs of nuts (73.5) to secure both rings (86.6, 86.7);
where a dual operation of hand braking and door detachment is achieved by pulling up the hand-brake lever (86) when the transport system, involved in the accident and/or catching fire, comes to a halt.

21. A rescue system according to claim 19, wherein release buttons (91.1, 91.1S) of the buckle assemblies (91, 91S), serving as the door-release levers, are provided with release wires (91.3), which are merged by a bracket (91.4) into a common release wire (91.5), which, deflected by a deflecting pulley (44), connected to the complementary exit tie member, deflected by the exit-member pivots of the transport system, is connected to a switch (91.6) of a motor (91.7).

22. A rescue system according to claim 19, wherein a trunk handle (88D) of the trunk cover (8Y), serving as the door-release lever, is provided with a dual-operation gear (G3) having a swinging arm (74), rotatable about the z₂-axis, comprising
a trunk-handle tie member, deflected by exit-member pivots of the transport system, one end of which is fastened to the trunk handle and the other end is fastened to a first ring (86.6);
a pipe (73.1), to one end of which a threaded pin (73.2) is fastened and to the other end an eye screw (73.4) is fastened, where the reduction-ratio is adjusted by moving the first ring (86.6) of the trunk-handle tie member along the threaded pin (73.2) and a second ring (86.7) of the complementary exit tie member (2n4) along the eye screw (73.4); and
two pairs of nuts (73.5) to secure both rings (86.6, 86.7);
where a dual operation of opening the trunk and detaching the vehicle doors is achieved by pulling the trunk handle (881)) when the transport system, involved in the accident and/or catching fire, comes to a halt.

23. A rescue system according to claim 19, wherein a handle (88C), arranged on the vehicle floor (13), serving as the door-release lever, is connected to the complementary exit tie member, deflected by the exit-member pivots of the transport system.

24. A rescue system according to claim 19, wherein serving as the door-release levers a grip (88A), located in a tank-space (77L), through which gasoline is filled and which is covered by a tank cap (87.2), is connected to the complementary exit tie member, deflected by the exit-member pivots of the transport system.

25. A rescue system according to claim 19, wherein the exit tie member of the vehicle door (8, 8S to 8Y), which among all vehicle doors (8, 8S to 8Y) of the transport system shows the highest rate of being jammed in the accidents, is provided with sites of predetermined fracture.

26. A rescue system for a transport system is equipped with a visible and audible warning system (70, 70a to 70c) comprising:
at least one crash sensor (84A to 84H) to sense an accident;
at least one fire sensor (84D) to sense fire (66), when broken in the transport system;
a navigator (71, 71a, 71b) with a storage medium;
a radio (83), equipped with loudspeakers (7a to 7n) and a storage medium;
a cell phone (72, 72a, 72b), equipped with a loudspeaker and a storage medium; and
text data (69), stored in one of the storage mediums;
a warning device (78) of the transport system with conventional warning lights (4a to 4n), provided with additional warning lights, arranged adjacent to a hand-brake lever (86) of a door-detachment device and door-release levers (88A to 88E) thereof,
where in the event of an accident and/or fire at least one of the sensors is activated to supply the warning device, navigator, radio and cell phone with current whereby the conventional and additional warning lights of the warning device, which are automatically switched on, flash in order to warn drivers of oncoming vehicles,
the additional warning lights help passengers and rescue workers find the hand-brake lever and door-release levers and
instructions, based on the text data, to operate the door-release levers are played back via the loudspeakers of the radio and the loudspeaker of the cell phone for the passengers and rescue workers.

27. A rescue system according to claim 26, wherein the text data (69) is coded in several languages.

28. A rescue system according to claim 26, wherein a 3-D crash sensor is provided for the warning system.

29. A rescue system according to claim 26, wherein the broadcasting member of the audible warning system is provided with an electromagnetic switch, supplied with current, when at least one of the sensors is activated, and switched on thereby.

30. A rescue system according to claim 26, wherein a battery (89) is connected to a main current circuit (79.1), to which major current circuits (79.11 to 79.14) of the warning device, navigator, radio, cell phone, current circuits (79.1a to 79.1d, 79.11f to 79.1h) of the sensors (84A to 84H) and a minor current circuit (79.2) are connected, where
to the minor current circuit (79.2) secondary current circuits (79.21 to 79.26) of the warning device, navigator, radio, cell phone and a motor (91.7) of the door-detachment device are connected; and
in the event of the accident and/or fire the power supply in the major current circuit is cut off while the warning device, navigator, radio, cell phone and the motor are supplied with current of the secondary current circuits, where the motor, when the transport system comes to a halt, activates the door-detachment device to automatically detach vehicle doors thereof from a vehicle body thereof.

31. A rescue system according to claim 26, wherein a battery (89) is connected to a main current circuit (79.1), to which major current circuits (79.11 to 79.14) of the warning device, navigator, radio, cell phone, current circuits (79.1a to 79.1d, 79.1f to 79.1h) of the sensors (84A to 84H) and a minor current circuit (79.2) are connected, where
to the minor current circuit (79.2) rechargeable batteries (89a), secondary current circuits (79.21 to 79.26) of the warning device, navigator, radio, cell phone and a motor (91.7) of the door-detachment device are connected; and
in the event of the accident and/or fire the power supply in the major current circuit (79.1) is cut off while the rechargeable batteries (89a) are responsible for the power supply for the secondary current circuits.
